(19) United States
(12) Patent Application Publication
(10) Pub. No.: US 2026/0319735 A1
(43) Pub. Date: Oct. 15, 2026

(54) NETWORK HANDOFF FOR PORTABLE PLAYBACK DEVICES

(71) Applicant: Sonos, Inc., Goleta, CA (US)

(72) Inventors: Kurt T. Soto, Ventura, CA (US); Gershon Dublon, London (GB); Erik Rieger, Edgewood, KY (US); Timothy A. Reilly, Louisville, KY (US)

(21) Appl. No.: 19/116,587

(22) PCT Filed: Sep. 29, 2023
(86) PCT No.: PCT/US2023/075491

§ 371 Date: Mar. 28, 2025

Related U.S. Application Data
(60) Provisional application No. 63/377,941, filed on Sep. 30, 2022.

(51) Int. Cl. G06F 3/16; H04R 27/00

(52) U.S. Cl. CPC G06F 3/165; H04R 27/00; H04R 2227/005; H04R 2420/07

(57) ABSTRACT

Techniques for coordinating network handoffs among devices in a playback system based on movement of a portable playback device are disclosed. Examples of one method include streaming audio content over a wireless communication link between a portable playback device and a playback device, playing back the audio content via the portable playback device, detecting a change in location of the portable playback device, readying another playback device for audio-content streaming by storing a buffered portion of the audio content in memory of the other playback device; detecting a further change in location of the portable playback device, and streaming the buffered portion of the audio content over another wireless communication link between the other playback device and the portable playback device, and continuing playback of the audio content via the portable playback device by playing back the buffered portion of the audio content streamed over the other wireless communication link.

### CROSS-REFERENCE TO RELATED APPLICATIONS

This application claims priority under 35 U.S.C. § 119(e), PCT Article 8, and Article 4 of the Paris Convention to co-pending U.S. Provisional Patent Application No. 63/377,941 filed on Sep. 30, 2022 and titled “NETWORK HANDOFF FOR PORTABLE PLAYBACK DEVICES,” which is incorporated herein by reference in its entirety for all purposes.

### TECHNICAL FIELD

The present disclosure relates to consumer goods and, more particularly, to methods, systems, products, aspects, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, titled “Method for Synchronizing Audio Playback between Multiple Networked Devices,” and began offering its first media playback system for sale in 2005. The SONOS Wireless Home Sound System enables people to experience music from many sources via one or more networked playback devices. Through a software control application installed on controller (e.g., a smartphone, tablet, computer, or voice input device) one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

Given the ever-growing interest in digital media, there continues to be a need to develop consumer-accessible technologies to further enhance the listening experience.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, the same or similar components that are illustrated are represented by a like reference numeral. For purposes of clarity, every component may not be labeled in every figure. In the figures:

FIG. 1A is a partial cutaway view of an environment having a media playback system configured in accordance with aspects of the disclosed technology;

FIG. 1B is a schematic diagram of the media playback system of FIG. 1A and one or more networks;

FIG. 2A is a functional block diagram of an example of a playback device;

FIG. 2B is an isometric diagram of an example of a housing of the playback device of FIG. 2A;

FIGS. 3A-3E are diagrams showing examples of playback device configurations in accordance with aspects of the disclosure;

FIG. 4A is a functional block diagram of an example of a controller device in accordance with aspects of the disclosure;

FIG. 5 is a functional block diagram of circuitry of an example of a network microphone device in accordance with aspects of the disclosure;

FIG. 6 is a conceptual diagram illustrating aspects of a positioning system architecture in accordance with aspects of the disclosure;

FIGS. 7A-C are diagrams illustrating an example of a media playback system environment in which network handoff systems and methods may be implemented in accordance with aspects of the disclosure; and

FIG. 8 is a flow diagram illustrating one example of a method of coordinating network handoffs in a media playback system, in according with aspects of the disclosure.

### DETAILED DESCRIPTION

### I. Overview

Portable audio playback devices offer a user great flexibility in being able to move around a home or other environment while listening to audio content. In some instances, the portable playback device receives, via a wireless communications link with a source device, an audio data stream corresponding to the audio content to be played. The source device may be a phone, computer, tablet, or other device capable of streaming audio content to the portable playback device via the wireless communications link. In some instances, this wireless communications link is a BLUETOOTH or other fairly short-range link. As such, as the user moves around with the portable playback device, the user may move the portable playback device out of range of the source device, resulting in loss of the signal needed to maintain playback of the audio content.

In circumstances where the portable playback device is being used in an environment in which a media playback system is deployed, such as environment 101 and media playback system 100 discussed below, for example, one or more other network devices in the media playback system may be available to act as source devices and stream audio content to the portable playback device. Therefore, according to certain aspects, as the portable playback device is moved out of range of one source device, another network device may automatically assume responsibility for streaming the audio content to the portable playback device, thus becoming the new source device and allowing the portable playback device to continue receiving and playing back the audio content. In certain examples, the network device(s) may act as a relay or intermediary between an original source device (such as a local or remote computing device, for example) and the portable playback device. In this manner, the effective range of the communication link with the portable playback device may be extended, thereby allowing the user greater freedom of movement while continuing to listen to the audio content played by the portable playback device.

Accordingly, aspects and embodiments are directed to systems and methods for directing and implementing network handoffs between a portable playback device and one or more network devices in a media playback system so as to allow for continued streaming of audio content to the portable playback device as the portable playback device is moved within an environment covered by the media playback system. As discussed in more detail below, various network devices in the media playback system can be assigned to become source devices for audio content to be played by the portable playback device, with the assignment being dynamic based on the location of the portable playback device at any given time. According to certain examples, movement of the portable playback device can be monitored as the portable playback device is moved within the environment, and one or more network devices can be dynamically assigned as a source device based on movement paths of the portable playback device. As discussed in more detail below, various localization techniques may be employed to determine and track the location of the portable playback device as it is moved around the environment. According to certain aspects, one or more network devices in the media playback system can be identified as potential future source devices based on a path of movement of the portable playback device, and the media playback system may take various actions to prepare these network devices to become the source device if the portable playback device continues along its expected trajectory.

In certain examples, the media playback system can be configured to cause one or more network devices proximate to the portable playback device to buffer and store audio content in preparation for potentially becoming the source device. Buffering and storing the audio content may be performed simultaneously with streaming the audio content and/or with playback of the audio content, as discussed further below. Further, examples of the media playback system may implement various messaging and communication processes to facilitate the handoff of audio content streaming from one network device to another as the portable playback device moves and/or as system conditions change. These processes may include exchanging information regarding a current source of the audio content, timing information to synchronize streaming and/or playback of the audio content during a handoff procedure so as to minimize “gaps” in the audio that may be heard by the user, information regarding a projected movement path of the portable playback device, information regarding the status or context of one or more network devices proximate the portable playback device, and/or other information, as discussed further below. Various other techniques and processes to streamline and facilitate smooth handoff procedures may be implemented, as also discussed below.

Thus, aspects and embodiments are directed to systems and methods for tracking the location of a portable playback device relative to one or more other network devices in a media playback system (MPS) and determining paths of movement of the portable playback device. Further aspects and embodiments provide for identifying one or more network devices as potential source devices for audio content to be streamed to the portable playback device based on the paths of movement and/or location of the portable playback device, and automatically assigning a selected network device as the source device. The assignment can be dynamic and automatically adjusted as conditions in the media playback system and/or environment change. In addition, network handoffs may occur automatically, without requiring action by a user. These capabilities may allow a user the ability to move freely about an environment while wearing headphones or carrying another type of portable playback device, without having to stay close to a particular source device (such as a BLUETOOTH enabled phone or computing device, for example). Rather, the portable playback device can dynamically “hop” from connectivity with one network device to another, establishing temporary streaming links with nearby network devices as needed.

Employing techniques and methods as disclosed herein, various embodiments may provide enhanced functionality within a media playback system and enhanced user experiences through automatically monitoring the movement of a portable playback device within an environment covered by the media playback system and coordinating the dynamic handoff of audio content streaming to the portable playback device from one network device to another to maintain connectivity with the portable playback device as it moves. As discussed in more detail below, monitoring the movement of the portable playback device can be achieved by collecting movement information from the portable playback device itself and receiving notifications from other playback devices when they detect the presence of the portable playback device. Presence detection can be accomplished using any of a variety of wireless communications or sensing technologies, examples of which are discussed further below.

According to certain embodiments, a system comprises at least one processor, and at least one non-transitory computer-readable memory storing program instructions that are executable by the at least one processor such that the system is configured to perform a method. The method comprises streaming audio content over a first wireless communication link between a portable playback device and a first playback device, playing back, via the portable playback device, the audio content streamed over the first wireless communication link, detecting a change in location of the portable playback device, and after detecting the change in location, readying a second playback device for audio-content streaming, wherein readying the second playback device comprises storing a buffered portion of the audio content in memory of the second playback device. The method further comprises detecting a further change in location of the portable playback device, and after detecting the further change in location of the portable playback device streaming the buffered portion of the audio content over a second wireless communication link between the second playback device and the portable playback device, and continuing playback of the audio content via the portable playback device, wherein continuing playback of the audio content comprises playing back the buffered portion of the audio content streamed over the second wireless communication link.

While some examples described herein may refer to functions performed by given actors, such as “users,” “listeners,” and/or other entities, it should be understood that such references are for purposes of explanation only. The claims should not be interpreted to require action by any such example actor unless explicitly required by the language of the claims themselves.

### II. Example Operating Environment

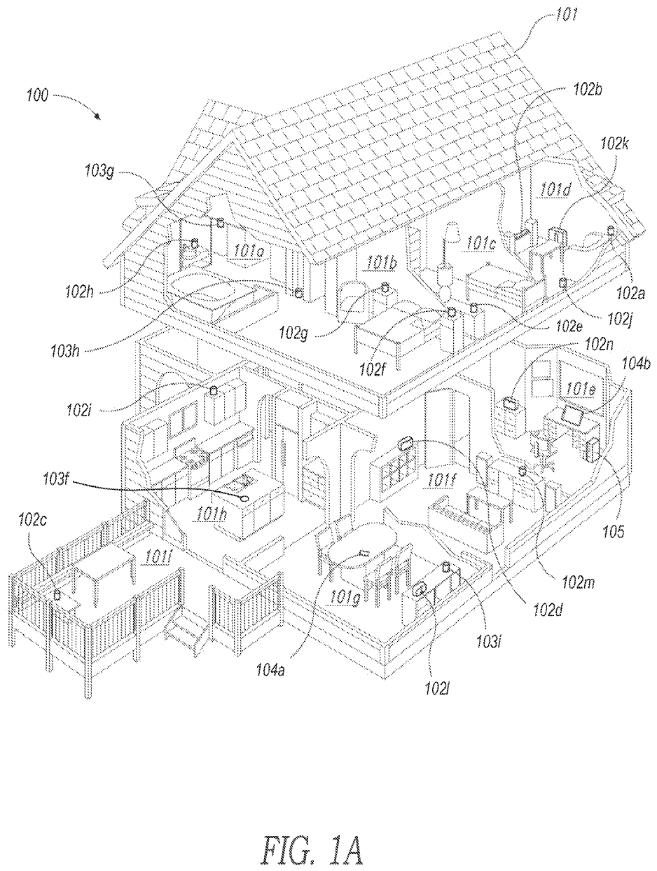

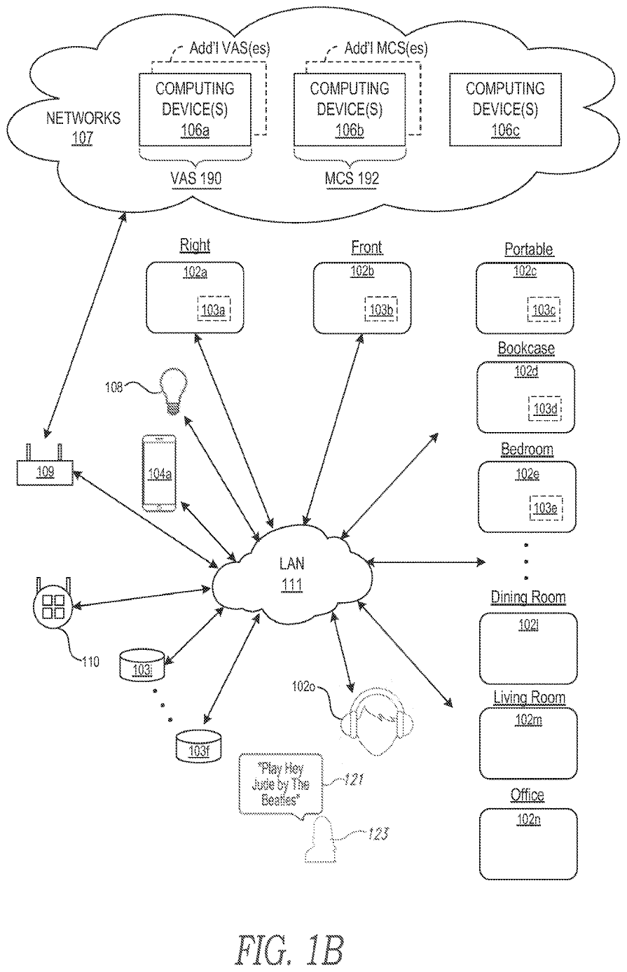

FIGS. 1A and 1B illustrate an example configuration of a media playback system 100 (or “MPS 100”) in which one or more examples disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b (referred to herein as “Nick's Room”), a second bedroom 101c, a family room or den 101d, an office 101e, a living room 101f, a dining room 101g, a kitchen 101h, and an outdoor patio 101i. While certain aspects and examples are described below in the context of a home environment, the technologies described herein may be implemented in other types of environments. In some examples, for instance, the MPS 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102o), network microphone devices 103 (identified individually as “NMDs” 103a-103i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A).

As used herein the term “playback device” can generally refer to a network device configured to receive, process, and output data of a media playback system, such as the MPS 100. For example, a playback device 102 can be a network device that receives and processes audio content. In some embodiments, a playback device 102 includes one or more transducers or speakers powered by one or more amplifiers, as discussed further below. In other embodiments, however, a playback device 102 includes one of (or neither of) the speaker and the amplifier. For instance, a playback device 102 can comprise one or more amplifiers configured to drive one or more speakers external to the playback device 102 via a corresponding wire or cable.

As used herein the term NMD (i.e., a “network microphone device”) can generally refer to a networked computing device that is configured for audio detection. As such, the NMD 103 may include a microphone that is configured to detect sounds in the NMD's environment.

In various implementations, one or more of the playback devices 102 may take the form of or include an on-board (e.g., integrated) network microphone device. A playback device 102 that includes components and functionality of an NMD 103 may be referred to as being “NMD-equipped.” For example, the playback devices 102a-e include or are otherwise equipped with corresponding NMDs 103a-e, respectively. In some cases, one or more of the NMDs 103 may be a stand-alone device. For example, the NMDs 103f and 103g may be stand-alone devices. A stand-alone NMD may omit components and/or functionality that is typically included in a playback device, such as speaker or related electronics. For instance, in such cases, a stand-alone NMD may not produce audio output or may produce limited audio output.

The term “control device” can generally refer to a network device configured to perform functions relevant to facilitating user access, control, and/or configuration of the media playback system 100.

In examples described below, one or more of the various playback devices 102 may be configured as portable playback devices, while others may be configured as stationary playback devices. For example, certain playback devices 102, such as the headphones 1020 (FIG. 1B) or the playback device 102c on the patio 101i, for example, may include an internal power source (e.g., a rechargeable battery) that allows the playback device to operate without being physically connected to a mains electrical outlet or the like. In this regard, such a playback device may be referred to herein as a “portable playback device.” On the other hand, playback devices that are configured to rely on power from a mains electrical outlet or the like (such as the playback device 102d, for example) may be referred to herein as “stationary playback devices,” although such devices may in fact be moved around a home or other environment. In practice, a person might often take a portable playback device to and from a home or other environment in which one or more stationary playback devices remain.

The various playback and network microphone devices 102 and 103 of the MPS 100 may each be associated with a unique name, which may be assigned to the respective devices by a user, such as during setup of one or more of these devices. For example, some playback devices may be assigned names according to a zone or room in which the playback devices are located. Further, certain playback devices may have functionally descriptive names. For example, the playback devices 102a and 102b are assigned the names “Right” and “Front,” respectively, because these two devices are configured to provide specific audio channels during media playback in the zone of the Den 101d (FIG. 1A). Other naming conventions are possible.

With reference still to FIG. 1B, the various playback, network microphone, and controller devices 102-104 and/or other network devices of the MPS 100 may be coupled to one another via point-to-point connections and/or over other connections, which may be wired and/or wireless, via a LAN 111 including a network router 109. For example, the playback device 102j in the Den 101d (FIG. 1A), which may be designated as the “Left” device, may have a point-to-point connection with the playback device 102a, which is also in the Den 101d and may be designated as the “Right” device. In a related example, the Left playback device 102j may communicate with other network devices, such as the playback device 102b, which may be designated as the “Front” device, via a point-to-point connection and/or other connections via the LAN 111.

As further shown in FIG. 1B, the MPS 100 may be coupled to one or more remote computing devices 106 via a wide area network (“WAN”) 107. In some examples, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the environment 101.

In some implementations, the various playback devices, NMDs, and/or controller devices 102-104 may be communicatively coupled to at least one remote computing device associated with a voice activated service (“VAS”) and at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS, or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless Home Sound Systems.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the LAN 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some examples, the remote computing device(s) and the media playback system 100 may exchange data via communication paths as described herein and/or using a metadata exchange channel as described in U.S. Pat. No. 10,499,146 filed Feb. 21, 2017, and titled “Voice Control of a Media Playback System,” which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in U.S. Pat. No. 10,499,146 referenced above.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 1021, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in U.S. Pat. No. 10,499,146 referenced above.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single playback device 102 and/or a single NMD 103. In some examples of such cases, the LAN 111 (FIG. 1B) may be eliminated and the single playback device 102 and/or the single NMD 103 may communicate directly with the remote computing devices 106a-d. In some examples, a telecommunication network (e.g., an LTE network, a 5G network, etc.) may communicate with the various playback, network microphone, and/or controller devices 102-104 independent of a LAN.

a. Example Playback & Network Microphone Devices

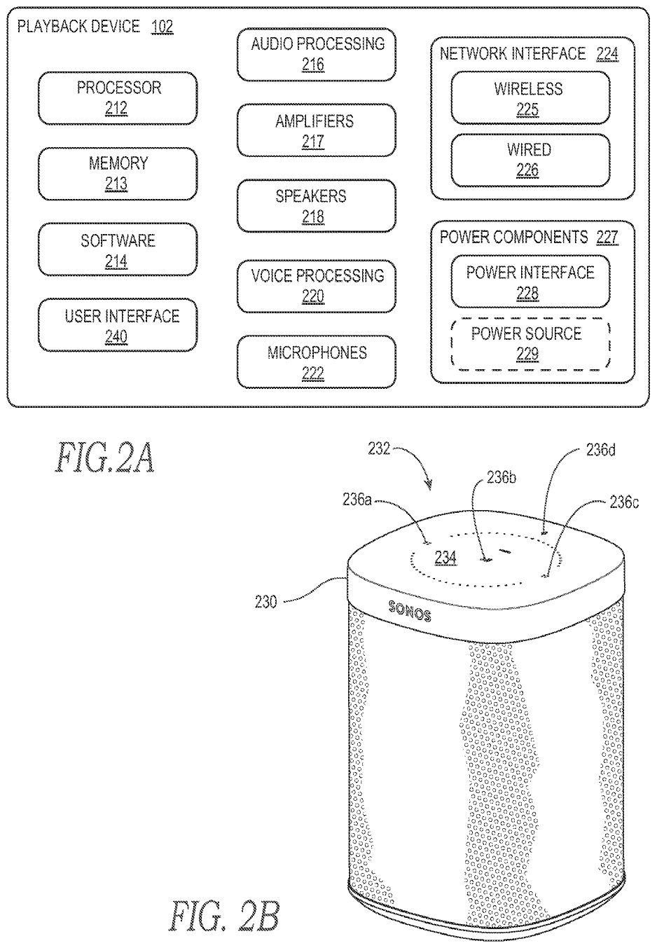

FIG. 2A is a functional block diagram illustrating certain aspects of one of the playback devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies, such as audible frequencies below about 500 Hz), a mid-range driver (e.g., for middle frequencies, such as audible frequencies between about 500 Hz and about 2 kHz), and/or a tweeter (e.g., for high frequencies, such as audible frequencies above 2 kHz). In some cases, a transducer may be driven by an individual corresponding audio amplifier of the audio amplifiers 217. In some implementations, a playback device may not include the speakers 218, but instead may include a speaker interface for connecting the playback device to external speakers. In certain examples, a playback device may include neither the speakers 218 nor the audio amplifiers 217, but instead may include an audio interface (not shown) for connecting the playback device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.11ax, 802.15, 4G or 5G mobile communication standard, WI-FI 4, 5, or 6 standards, and so on). The wireless interface(s) 225 may also enable the playback device 102 to communicate using technologies and protocols such as BLUETOOTH, ultrasound, acoustic signaling, and ultra-wideband radio, to name a few. A wired interface may provide network interface functions for the playback device 102 to communicate over a wired connection with other devices in accordance with a communication protocol (e.g., IEEE 802.3). While the network interface 224 shown in FIG. 2A includes both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the playback device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphone).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

In some implementations, the voice-processing components 220 may detect and store a user's voice profile, which may be associated with a user account of the MPS 100. For example, voice profiles may be stored as and/or compared to variables stored in a set of command information or data table. The voice profile may include aspects of the tone or frequency of a user's voice and/or other unique aspects of the user's voice, such as those described in U.S. Pat. No. 10,499,146 referenced above.

As further shown in FIG. 2A, the playback device 102 also includes power components 227. The power components 227 include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independently of an external power source. In some such implementations, the external power source interface 228 may be configured to facilitate charging the internal power source 229. As discussed above, a playback device comprising an internal power source may be referred to herein as a “portable playback device.” On the other hand, a playback device that operates using an external power source may be referred to herein as a “stationary playback device,” although such a device may in fact be moved around a home or other environment.

The playback device 102 further includes a user interface 240 that may facilitate user interactions independent of or in conjunction with user interactions facilitated by one or more of the controller devices 104. In various examples, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive sound from the environment of the playback device 102. The microphones 222 may be arranged in various positions along and/or within the top portion 234 or other areas of the housing 230 so as to detect sound from one or more directions relative to the playback device 102.

By way of illustration, Sonos, Inc. presently offers (or has offered) for sale certain playback devices that may implement certain of the examples disclosed herein, including a “PLAY:1,” “PLAY:3,” “PLAY:5,” “PLAYBAR,” “CONNECT: AMP,” “PLAYBASE,” “BEAM,” “CONNECT,” “AMP,” “PORT,” and “SUB.” Any other past, present, and/or future playback devices may additionally or alternatively be used to implement the playback devices of example aspects disclosed herein. Additionally, it should be understood that a playback device is not limited to the examples illustrated in FIG. 2A or 2B or to the Sonos product offerings. For example, a playback device may include, or otherwise take the form of, a wired or wireless headphone set, which may operate as a part of the media playback system 100 via a network interface or the like. In another example, a playback device may include or interact with a docking station for personal mobile media playback devices. In yet another example, a playback device may be integral to another device or component such as a television, an LP turntable, a lighting fixture, or some other device for indoor or outdoor use.

b. Example Playback Device Configurations

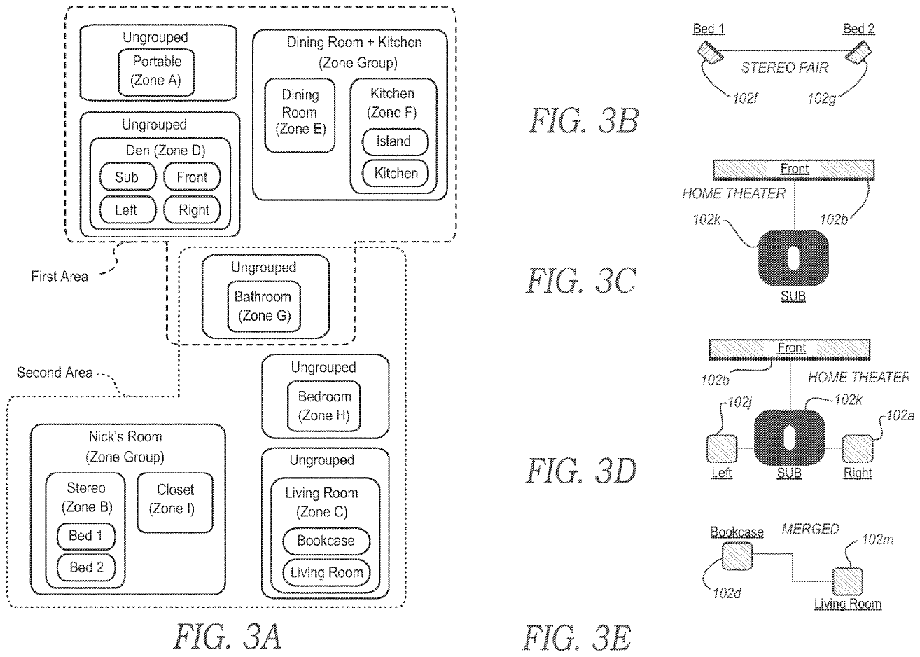

FIGS. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the playback device 102g (FIG. 1A) named “Bed 2” in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various examples, a zone may take on the name of one of the playback devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some examples, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101h (FIG. 1A) and the Bed 2 device may be the playback device 102g also in the master bedroom 101h (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one example, the playback devices 102d and 102m may playback audio in synchrony, during which each outputs the full range of audio content that each respective playback device 102d and 102m is capable of rendering.

In some examples, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD device 103f named “Island” may be bonded with the playback device 102i Kitchen, which together form Zone F, which is also named “Kitchen.” Additional details regarding assigning NMDs and playback devices as designated or default devices may be found, for example, in U.S. Pat. No. 10,499,146 referenced above. In some examples, a stand-alone NMD may not be assigned to a zone.

Zones of individual, bonded, and/or merged devices may be arranged to form a set of playback devices that playback audio in synchrony. Such a set of playback devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in U.S. Pat. No. 8,234,395 referenced above. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room +Kitchen,” as shown in FIG. 3A. In some examples, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the media playback system 100, which may be shared from time to time among the devices so that one or more of the devices have the most recent data associated with the system.

In some examples, the memory 213 of the playback device 102 may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that devices 103f and 102i are bonded. Identifiers associated with the Kitchen may indicate the same or similar information by virtue of the Kitchen being part of the Dining Room+Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. Pat. No. 10,712,997 filed Aug. 21, 2017 and titled “Room Association Based on Name,” and U.S. Pat. No. 8,483,853 filed Sep. 11, 2007, and titled “Controlling and manipulating groupings in a multi-zone media system,” each of which is incorporated herein by reference in its entirety. In some examples, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In examples described below, the memory 213 is configured to store a set of command data for selecting a particular VAS when processing voice inputs.

During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone. For instance, the user may be in the Office zone where the playback device 102n is playing the same hip-hop music that is being played by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in U.S. Pat. No. 8,234,395 referenced above.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. In other instances, the MPS may automatically reconfigure one or more playback devices based on tracking the movement of at least one portable playback device and acquiring localization information for the at least one portable playback devices, as discussed in more detail below. As another example, if one or more playback devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

c. Example Controller Devices

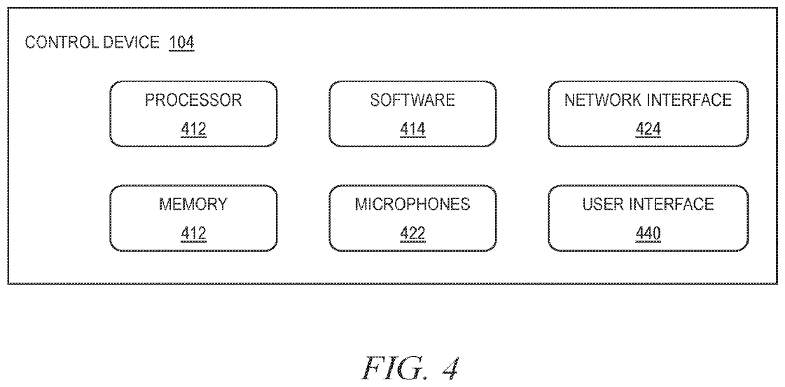

FIG. 4A is a functional block diagram illustrating certain aspects of a selected one of the controller devices 104 of the MPS 100 of FIG. 1A. Such controller devices may also be referred to herein as a “control device” or “controller.” The controller device shown in FIG. 4A may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others. Accordingly, the controller device includes a user interface 440 that is generally configured to facilitate user access and control of the MPS 100. The user interface 440 may include a touch-screen display or other physical interface configured to provide various graphical controller interfaces to allow a user to interact with the MPS 100. For example, the user interface 440 may allow the user to instruct one or more playback devices 102 to play music (including actions such as pause, skip, fast forward, stop, etc.), view, create, and/or modify playback zones or playback device groupings within the MPS 100, view information about the music being played (e.g., song title, artist, etc.), and/or create, modify, and view playlists, among various other activities. Examples of controller devices 104 are described in more detail in above-referenced U.S. Pat. No. 10,499,146, for example.

d. Example Audio Content Sources

The audio sources in the sources region 448 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some examples, audio content may be provided by one or more media content services.

Example audio content sources may include a memory of one or more playback devices in a media playback system such as the MPS 100 of FIG. 1A, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

e. Example Network Microphone Devices

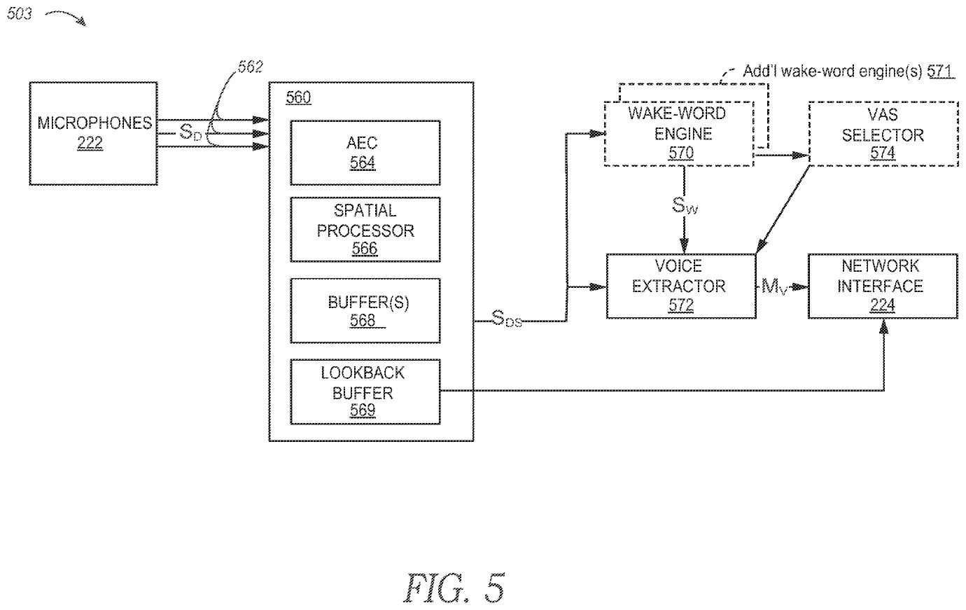

FIG. 5 is a functional block diagram showing an NMD 503 configured in accordance with aspects of the disclosure. The NMD 503 includes voice capture components (“VCC”, or collectively “voice processor 560”), and optionally also includes a wake-word engine 570, and at least one voice extractor 572, each of which is operably coupled to the voice processor 560. The NMD 503 further includes the microphones 222 and the at least one network interface 224 described above and may also include other components, such as audio amplifiers, interface, etc., which are not shown in FIG. 5 for purposes of clarity.

The microphones 222 of the NMD 503 are configured to provide detected sound, S_{D}, from the environment of the NMD 503 to the voice processor 560. The detected sound S_{D} may take the form of one or more analog or digital signals. In example implementations, the detected sound S_{D} may be composed of a plurality of signals associated with respective channels 562 that are fed to the voice processor 560.

Each channel 562 may correspond to a particular microphone 222. For example, an NMD having six microphones may have six corresponding channels. Each channel of the detected sound SD may bear certain similarities to the other channels but may differ in certain regards, which may be due to the position of the given channel's corresponding microphone relative to the microphones of other channels. For example, one or more of the channels of the detected sound SD may have a greater signal to noise ratio (“SNR”) of speech to background noise than other channels.

As further shown in FIG. 5, the voice processor 560 includes an AEC 564, a spatial processor 566, and one or more buffers 568. In operation, the AEC 564 receives the detected sound SD and filters or otherwise processes the sound to suppress echoes and/or to otherwise improve the quality of the detected sound S_{D}. That processed sound may then be passed to the spatial processor 566.

The spatial processor 566 is typically configured to analyze the detected sound S_{D} and identify certain characteristics, such as a sound's amplitude (e.g., decibel level), frequency spectrum, directionality, etc. In one respect, the spatial processor 566 may help filter or suppress ambient noise in the detected sound S_{D}from potential user speech based on similarities and differences in the constituent channels 562 of the detected sound S_{D}, as discussed above. As one possibility, the spatial processor 566 may monitor metrics that distinguish speech from other sounds. Such metrics can include, for example, energy within the speech band relative to background noise and entropy within the speech band—a measure of spectral structure—which is typically lower in speech than in most common background noise. In some implementations, the spatial processor 566 may be configured to determine a speech presence probability, examples of such functionality are disclosed in U.S. Pat. No. 10,847,178, filed May 18, 2018, titled “Linear Filtering for Noise-Suppressed Speech Detection,” and U.S. Pat. No. 10,692,518, filed Sep. 29, 2018, and titled “Linear Filtering for Noise-Suppressed Speech Detection via Multiple Network Microphone Devices,” each of which is incorporated herein by reference in its entirety.

If the NMD 503 includes a wake-word engine 570, the wake-word engine 570 can be configured to monitor and analyze received audio to determine if any wake words are present in the audio. The wake-word engine 570 may analyze the received audio using a wake word detection algorithm. If the wake-word engine 570 detects a wake word, a network microphone device may process voice input contained in the received audio. In some examples, the wake-word engine 570 runs multiple wake word detection algorithms on the received audio simultaneously (or substantially simultaneously). As noted above, different voice services (e.g. AMAZON's ALEXA, APPLE's SIRI, MICROSOFT's CORTANA, GOOGLE'S Assistant, etc.) each use a different wake word for invoking their respective voice service. To support multiple services, the wake-word engine 570 may run the received audio through the wake word detection algorithm for each supported voice service in parallel. In such examples, the network microphone device 103 may include VAS selector components 574 configured to pass voice input to the appropriate voice assistant service.

In operation, the one or more buffers 568—one or more of which may be part of or separate from the memory 213 (FIG. 2A)—capture data corresponding to the detected sound S_{D}. More specifically, the one or more buffers 568 capture detected-sound data that was processed by the upstream AEC 564 and spatial processor 566.

In general, the detected-sound data form a digital representation (i.e., sound-data stream), SDS, of the sound detected by the microphones 222. In practice, the sound-data stream S_{DS} may take a variety of forms. As one possibility, the sound-data stream S_{DS} may be composed of frames, each of which may include one or more sound samples. The frames may be streamed (i.e., read out) from the one or more buffers 568 for further processing by downstream components, such as the wake-word engine 570 and the voice extractor 572 of the NMD 503.

In some implementations, at least one buffer 568 captures detected-sound data utilizing a sliding window approach in which a given amount (i.e., a given window) of the most recently captured detected-sound data is retained in the at least one buffer 568 while older detected-sound data are overwritten when they fall outside of the window. For example, at least one buffer 568 may temporarily retain 20 frames of a sound specimen at given time, discard the oldest frame after an expiration time, and then capture a new frame, which is added to the 19 prior frames of the sound specimen.

In practice, when the sound-data stream Sos is composed of frames, the frames may take a variety of forms having a variety of characteristics. As one possibility, the frames may take the form of audio frames that have a certain resolution (e.g., 16 bits of resolution), which may be based on a sampling rate (e.g., 44,100 Hz). Additionally, or alternatively, the frames may include information corresponding to a given sound specimen that the frames define, such as metadata that indicates frequency response, power input level, signal-to-noise ratio, microphone channel identification, and/or other information of the given sound specimen, among other examples. Thus, in some examples, a frame may include a portion of sound (e.g., one or more samples of a given sound specimen) and metadata regarding the portion of sound. In other examples, a frame may only include a portion of sound (e.g., one or more samples of a given sound specimen) or metadata regarding a portion of sound.

The voice processor 560 also includes at least one lookback buffer 569, which may be part of or separate from the memory 213 (FIG. 2A). In operation, the lookback buffer 569 can store sound metadata that is processed based on the detected-sound data S_{D} received from the microphones 222. As noted above, the microphones 222 can include a plurality of microphones arranged in an array. The sound metadata can include, for example: (1) frequency response data for individual microphones of the array, (2) an echo return loss enhancement measure (i.e., a measure of the effectiveness of the acoustic echo canceller (AEC) for each microphone), (3) a voice direction measure; (4) arbitration statistics (e.g., signal and noise estimates for the spatial processing streams associated with different microphones); and/or (5) speech spectral data (i.e., frequency response evaluated on processed audio output after acoustic echo cancellation and spatial processing have been performed). Other sound metadata may also be used to identify and/or classify noise in the detected-sound data S_{D}. In at least some examples, the sound metadata may be transmitted separately from the sound-data stream S_{DS}, as reflected in the arrow extending from the lookback buffer 569 to the network interface 224. For example, the sound metadata may be transmitted from the lookback buffer 569 to one or more remote computing devices separate from the VAS which receives the sound-data stream S_{DS}. In some examples, for instance, the metadata can be transmitted to a remote service provider for analysis to construct or modify a noise classifier.

Components of the NMD 503 downstream of the voice processor 560 may process the sound-data stream S_{DS}. For instance, the wake-word engine 570 can be configured to apply one or more identification algorithms to the sound-data stream S_{DS} (e.g., streamed sound frames) to spot potential wake words in the detected-sound S_{D}. When the wake-word engine 570 spots a potential wake word, the wake-word engine 570 can provide an indication of a “wake-word event” (also referred to as a “wake-word trigger”) to the voice extractor 572 in the form of signal S_{W}.

In response to the wake-word event (e.g., in response to a signal S_{W} from the wake-word engine 570 indicating the wake-word event), the voice extractor 572 is configured to receive and format (e.g., packetize) the sound-data stream S_{DS}. For instance, the voice extractor 572 packetizes the frames of the sound-data stream S_{DS} into messages. The voice extractor 572 transmits or streams these messages, M_{V}, that may contain voice input in real time or near real time to a remote VAS, such as the VAS 190 (FIG. 1B), via the network interface 224.

With continued reference to FIG. 5, in multi-VAS implementations, the NMD 503 may include a VAS selector 574 (shown in dashed lines) that is generally configured to direct the voice extractor's extraction and transmission of the sound-data stream S_{DS} to the appropriate VAS when a given wake-word is identified by a particular wake-word engine, such as the first wake-word engine 570a, the second wake-word engine 570b, or the additional wake-word engine 571. In such implementations, the NMD 503 may include multiple, different wake-word engines and/or voice extractors, each supported by a particular VAS.

### III. Positioning System Examples

As discussed above, a plurality of network devices, such as playback devices 102 and/or NMDs 103, can be distributed within an environment 101, such as a user's home, or a commercial space such as a restaurant, retail store, mall, hotel, etc. Some of the devices may be in relatively fixed locations within the environment 101, whereas others may be portable and be frequently moved from one location to another. As the capabilities of these devices expand, it is becoming increasingly desirable to locate and interact with devices within the environment 101. According to certain aspects, a positioning system can be implemented to determine relative positioning of devices within the environment 101 and optionally to control or modify behavior of one or more devices based on the relative positions. Positioning or localization information can be acquired through various techniques, optionally using sensors in some instances, examples of which are discussed below. Location of a network device may refer to the device's relative location (e.g., relative to one or more other network devices in the media playback system), absolute location, geographic location, etc. A device's position may refer to its location, orientation, proximity to other devices, etc. In certain examples, one or more devices in the MPS 100, such as one or more playback devices 102, NMDs 103, or controller devices 104 may host a localization application that may implement operations (also referred to herein as functional capabilities or functionalities) that process localization information to enhance user experiences with the MPS 100. Examples of such operations include sophisticated acoustic manipulation (e.g., functional capabilities directed to psychoacoustic effects during audio playback) and autonomous device configuration/reconfiguration (e.g., functional capabilities directed to detection and configuration of new devices or devices that have moved or otherwise been changed in some way), among others. The requirements that these operations place on localization information vary, with some operations requiring low latency, high precision localization information and other operations being able to operate using high latency, low precision localization information.

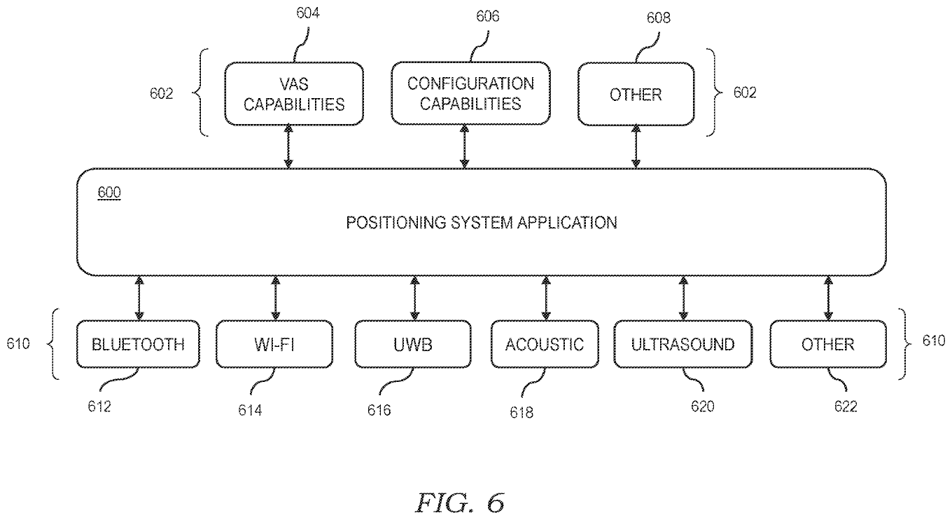

According to certain examples, a positioning system can be implemented in the MPS 100 using a variety of different devices to generate the localization information utilized by certain application functionalities. However, the number, arrangement, and configuration of these devices can vary between examples. Additionally or alternatively, the communications technology and/or sensors employed by the devices can vary. Given the number of variables in play within any particular MPS and the concomitant inefficiencies that this variability imposes on MPS application operation development and maintenance, some examples disclosed herein utilize one or more playback devices 102, NMDs 103, or controller devices 104 to implement a positioning system using a common positioning application programming interface (API) that decouples the positioning/localization information from specific devices or underlying enabling technologies, as illustrated conceptually in FIG. 6.

Referring to FIG. 6, any one or more playback devices 102, NMDs 103, or controller devices 104 in the MPS 100 (“MPS devices”) can host a positioning system application 600. In certain implementations, one or more remote computing devices can facilitate hosting the application. The positioning system application 600 implements an application programming interface (API) that exposes positioning/localization information, and metadata pertinent thereto, to MPS application functionalities 602. The MPS functionalities 602 may include a wide variety of functional capabilities relating to various user experiences and aspects of the operation of the MPS 100. For example, the MPS functionalities 602 may include one or more VAS capabilities 604, such as voice disambiguation operations and arbitration between different NMDs receiving the same voice inputs, for example. The MPS functionalities 602 may also include one or more MPS and/or device configuration capabilities 606, such as automatic home theatre configuration or reconfiguration, dynamically accommodating portable playback devices in home theatre environments, dynamic room assignment for portable playback devices or their associated docks, and contextual orientation of controller devices 104, to name a few. The MPS functionalities 602 may further include one or more other capabilities 608 that use positioning/localization information. To support these and other MPS functionalities 602, positioning/localization information may be used to determine various pieces of information related to the locations of MPS devices within the environment 101. For example, the positioning/localization information may be used by some MPS functionalities 602 to keep track of which playback devices 102 or NMDs 103 are in a given room or space (e.g., which playback devices are in the living room 101f, in which room is playback device 102d, or which playback devices 102 are closest to the controller device 104). The positioning/localization information may further be used to determine the distance and/or orientation between playback devices 102 (with varying levels of precision), or to determine the acoustic space around NMDs 103 or NMD-equipped playback devices 102 (e.g., which playback devices 102 can be heard from NMD 103a). Thus, the positioning/localization information may be used to determine information about the topology of the MPS 100 within the environment 101, which information may then be used to automatically and dynamically create or modify user experiences with the MPS 100 and support the MPS functionalities 602.

In some examples, the positioning/localization information is obtained through the exchange of wireless signals among network devices (point-to-point signaling) within the MPS 100. For example, in response to a signaling trigger, some or all of the MPS devices emit one or more wireless signals and “listen” for the wireless signals emitted by other MPS devices. Each of the wireless signal can include a device identifier that identifies the network device from which the respective wireless signal was emitted. Based on detecting the various wireless signals, one or more of the MPS devices can determine certain positioning/localization information. For example, one or more MPS devices may establish a reference pattern that describes distances and directions between MPS devices based on signal strength measurements. In another example, an MPS device may detect the presence of another MPS device based on detecting the wireless signal(s) emitted by the other MPS device. In some examples, the signaling trigger is based on a schedule. For example, some or all of the MPS devices can be configured to periodically emit and/or listen for wireless signals. In another example, a coordinating MPS device may broadcast an instruction to other MPS devices directing the other MPS devices to emit and/or listen for wireless signals. In another example, a portable playback device that detects its movement (e.g., through an on-board sensor, such as a inertial measurement unit, or through connection to or disconnection from its docking station, or via some other mechanism)may broadcast a request for other MPS devices to emit the wireless signals, such that the portable playback device can determine its new position relative to one or more of the other MPS devices by detecting the wireless signals emitted by the one or more other MPS devices. Various other examples are possible.

The positioning/localization information and metadata exposed by the positioning system application 600 may vary depending on the underlying communications technologies and/or sensor capabilities 610 within the MPS devices that are used to acquire the information and/or the needs of the particular MPS functionality 602. For example, certain MPS devices may be equipped with one or more network interfaces 224 that support any one or more of the following communications capabilities: BLUETOOTH 612, WI-FI 614 or ultra wide-band technology (UWB 616; a short-range radio frequency communications technology). Further, certain MPS devices may be equipped to support signaling via acoustic signaling 618, ultrasound 620, or other signaling and/or communications means 622. Certain technologies 610 may be well-suited to certain MPS functionalities 602 while others may be more useful in other circumstances. For example, UWB 616 may provide high precision distance measurements, whereas WI-FI 614 (e.g., using RSSI signal strength measurements) or ultrasound 620 may provide “room-level” topology information (e.g., presence detection indicating that a particular MPS device is within a particular room or space of the environment 101). In some examples, combinations of the different technologies 610 may be used to enhance the accuracy and/or certainty of the information derived from the positioning/localization information received from one or more MPS devices via the positioning system application 600. For example, as discussed further below, in some instances, presence detection may be performed primarily using ultrasound 620; however, RSSI measurements may be used to confirm the presence detection and/or provide more precise localization information in addition to the presence detection.

Examples of MPS devices equipped with ultrasonic presence detection are disclosed in U.S. Patent Publication Nos. 2022/0066008 and 2022/0261212, each of which is hereby incorporated herein by reference in its entirety for all purposes. Examples of localizing MPS devices based on RSSI measurements are disclosed in U.S. Patent Publication No. 2021/0099736, which is incorporated herein by reference in its entirety for all purposes. Examples of performing location estimation of MPS devices using WI-FI 614 are disclosed in U.S. Patent Publication No. 2021/0297168, which is incorporated herein by reference in its entirety for all purposes.

In addition to the positioning/localization information itself, some examples of the positioning system application 600 can expose metadata that specifies localization capabilities of the host MPS device, such as precision and latency information and availability of the various underlying capabilities 610. As such, the positioning system application 600 enables the MPS functionalities 602 each to utilize a common set of API calls to identify the localization capability present within their host MPS device and to access positioning/localization information made available through the identified capabilities 610.

As shown in FIG. 6 and discussed above, the positioning system application 600 can interoperate with MPS devices that support a wide variety of localization capabilities, such as BLUETOOTH 612, WI-FI 614, UWB 616, acoustic signaling 618 and/or ultrasound 620, among others 622. In some examples, the positioning system application 600 includes one or more adapters configured to communicate with MPS devices using syntax and semantics specific to the localization capability 610 of the MPS devices. This architecture shields the MPS functionalities 602 from the complexity of interoperating with each type of MPS device. In some examples, each adapter can receive and process a stream of positioning/localization data from the MPS devices using any one or more of the communications capabilities 610. The adapters can interoperate with an accumulation engine within the positioning system application 600 that analyzes and merges (e.g., using a set of configurable rules) positioning/localization data obtained by the adapters and populates data structures that contain the positioning/localization information and the metadata described above. These data structures, in turn, are accessed and the positioning/localization information, and metadata, are retrieved by the positioning system application 600 in response to API calls received by the positioning system application 600 to support the MPS functionalities 602. The positioning/localization information, and metadata, can specify, in some examples, position/location of a device relative to other devices, absolute position/location (e.g., within a coordinate system) of a device, presence of device (e.g., within a structure, room, or as a simple Boolean value), and/or orientation of a device.

For instance, in some examples, the positioning/localization information is expressed in two dimensions (e.g., as coordinates in a Cartesian plane), in three dimensions (e.g., as coordinates in a Cartesian space), or as coordinates within other coordinate systems. In certain examples, the positioning/localization information is stored in one or more data structures that include one or more records of fields typed and allocated to store portions of the information. For instance, in at least one example, the records are configured to store timestamps in association with values indicative of location coordinates of a network device taken at a time given by the associated timestamp. The records may be configured to store various other information as well. Other examples of positioning/localization information, and structures configured to store the same, will be apparent in view of this disclosure.

It should be noted that the API and adapters implemented by the positioning system application 600 may adhere to a variety of architectural styles and interoperability standards. For instance, in one example, the API is a web services interface implemented using a representational state transfer (REST) architectural style. In this example, the API communications are encoded in Hypertext Transfer Protocol (HTTP) along with JavaScript Object Notation and/or extensible markup language. In some examples, portions of the HTTP communications are encrypted to increase security. Alternatively or additionally, in some examples, the API is implemented as a . NET web API that responds to HTTP posts to particular URLs (API endpoints) with localization data or metadata. Alternatively or additionally, in some examples, the API is implemented using simple file transfer protocol commands. Also, in some examples, the adapters are implemented using a proprietary application protocol accessible via a user datagram protocol socket. Thus, the adapters and the API as described herein are not limited to any particular implementation.

### IV. Examples of Network Handoff Techniques for Portable Playback Devices

As discussed above, aspects and embodiments are directed to monitoring movement of a portable playback device within an environment and automatically assigning different network devices to be source devices for audio content streamed to the portable playback device based on the movement to support an uninterrupted playback session on the portable playback device as it is moved around the environment.

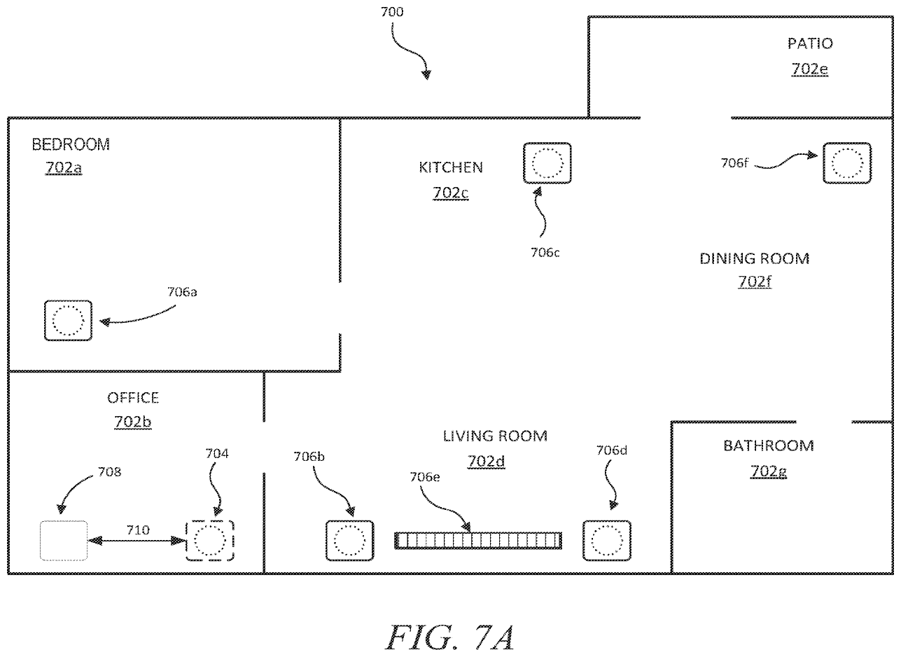

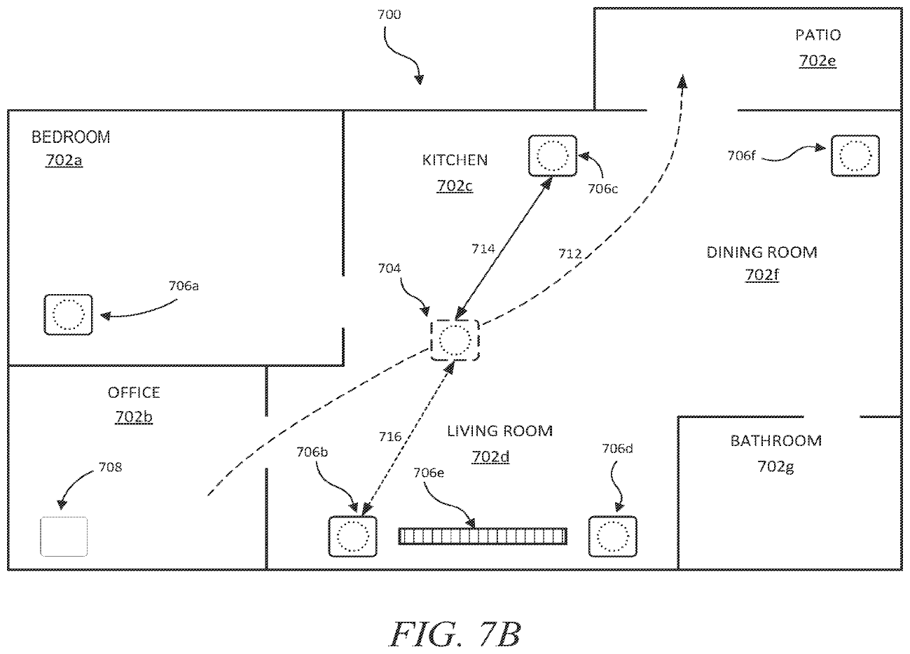

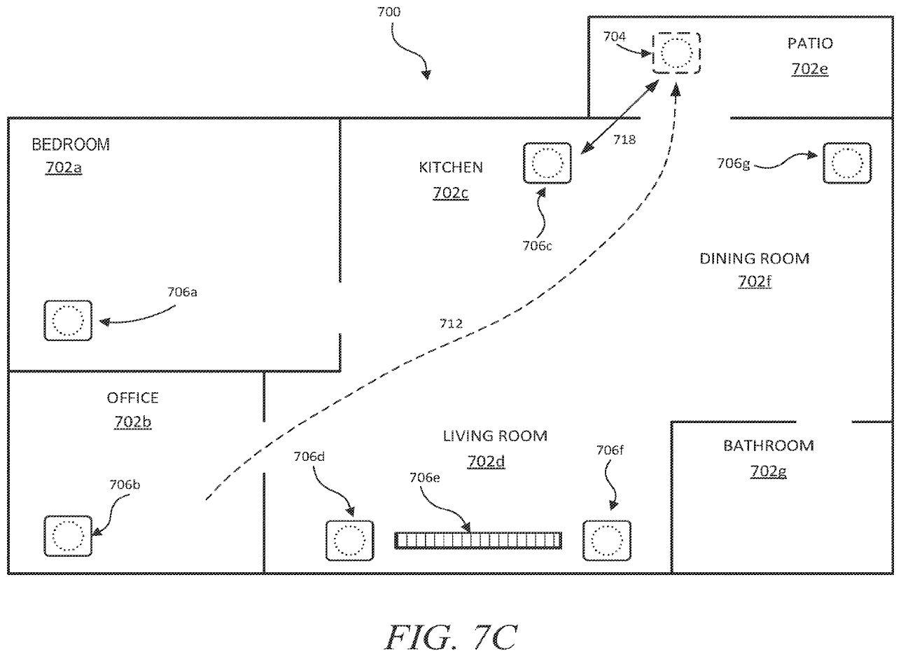

Referring to FIGS. 7A-C, there is illustrated an environment 700 (e.g., environment 101 discussed above) in which a media playback system (e.g., such as MPS 100 discussed above) including a plurality of playback devices is installed and in which movement monitoring and network handoff systems and methods according to certain examples can be implemented. In the illustrated example, the environment 700 includes several rooms and spaces identified as Bedroom 702a, Office 702b, Kitchen 702c, Living Room 702d, Patio 702e, Dining Room 702f, and Bathroom 702g; however, it is to be appreciated that the environment 700 may include additional, fewer, or other rooms/spaces and the example shown in FIGS. 7A-C is for purposes of illustration only. In the illustrated example, the media playback system includes a portable playback device 704 and a plurality of network devices 706 (identified individually as network devices 706a-f). The network devices 706 may be playback devices 102, NMDs 103, NMD-equipped playback devices 102, or controller devices 104. The media playback system may include additional playback devices, NMDs, and/or controller devices not shown in FIGS. 7A-C. Further, in other examples, the media playback system may include fewer than seven network devices 706. The network devices 706 may be stationary network devices that have relatively fixed positions within the environment 700 and in at least certain instances, their locations within the environment 700 and/or relative to one another may be known (e.g., from set-up and/or through various localization techniques). The network devices 706 may communicate with one another over a wireless communication network, such as LAN 111 (FIG. 1B) discussed above.

As discussed above, during a playback session, the portable playback device 704 may receive an audio data stream corresponding to audio content to be played by the portable playback device 704. The portable playback device 704 may receive this audio content via a wireless communication link established between the portable playback device 704 and a source device that streams the audio content to the portable playback device. In certain examples, the wireless communication link is a BLUETOOTH link; however, in other examples, the communication link may be implemented using another radio frequency (RF) communication technology, such as WI-FI or ultra wide-band (UWB), for example. Accordingly, while various examples discussed below may refer to the use of BLUETOOTH communication links and BLUETOOTH enabled devices, those skilled in the art will appreciate, given the benefit of this disclosure, that other implementations are possible and the particular examples discussed herein are illustrative and not intended to be limiting.

In the example shown in FIG. 7A, the portable playback device 704 is located in the Office 702b, and may receive an audio data stream from a source device 708 over a first wireless communication link 710. The source device 708 may receive this audio stream from, e.g., a remote content source, such as a cloud streaming service, or a local source, such as an A/V source. The source device 708 may be a local computing device, such as the local computing device 105 discussed above (FIG. 1A), for example, a phone, computer, or tablet, to name a few examples. In some examples, the source device 708 may be a network device 706. The portable playback device 704 may be headphones or another type of battery-powered, carryable playback device. In some instances, a user may wish to move around the environment 700 with the portable playback device 704 while continuing to listen to audio content played by the portable playback device 704. However, such movement may cause the portable playback device 704 to move beyond the effective (or usable) wireless range of source device 708 such that the first wireless communication link 710 is broken and the portable playback device 704 can no longer receive the audio data stream from the source device 708. Accordingly, as discussed above, aspects and embodiments provide a solution, allowing one or more network devices 706 to become source devices for the audio content streamed to the portable playback device 704, thereby enabling free movement of the portable playback device 704 within the environment 700 without disrupting the playback session, regardless of the location of the source device 708.

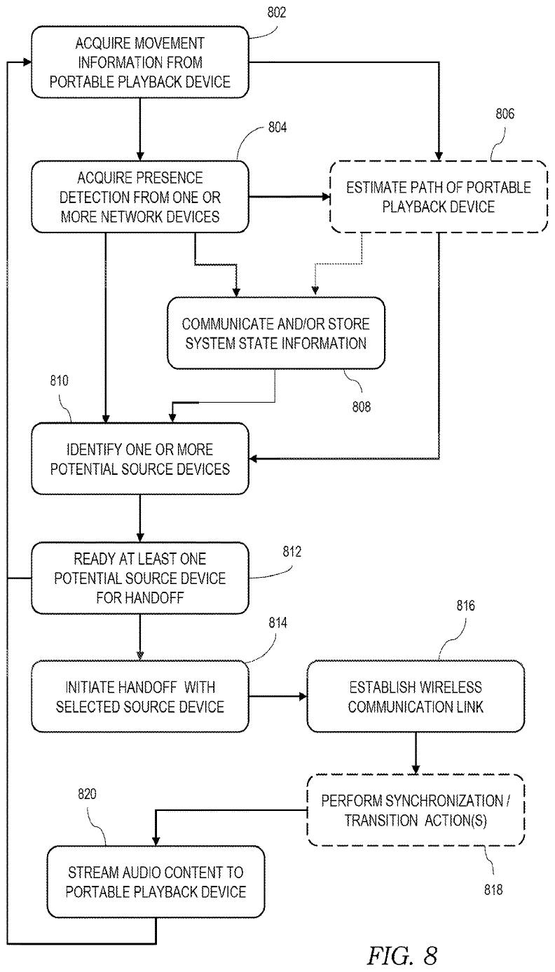

An illustrative example in which the portable playback device 704 is moved from the Office 702b to the Patio 702e is discussed below with reference to FIGS. 7B, 7C, and 8.

As the portable playback device 704 is moved around the environment 700, its location can be monitored using a combination of movement information reported by the portable playback device 704 itself and localization information acquired from one or more of the network devices 706. In some examples, the portable playback device 704 may include one or more motion sensors configured to obtain movement/location measurements for the portable playback device 704. The network devices 706 can be configured to detect the presence of the portable playback device 704 when the portable playback device 704 is in their proximity, and provide notifications of that detection. Based on the detection information, positional information about the portable playback device 704 can be determined. The positional information and/or movement information can be expressed, for example, in two dimensions (e.g., as coordinates in a Cartesian plane), three dimensions (e.g., as coordinates in a Cartesian space), or as movement/positions within other coordinate systems. In certain examples, the movement information and/or the positional information is stored in one or more data structures that include one or more records of fields typed and allocated to store portions of the information. For instance, in at least one example, the records are configured to store timestamps in association with values indicative of location coordinates of a portable playback device taken at a time given by the associated timestamp. Further, in at least one example, the records are configured to store timestamps in association with values indicative of a velocity of a portable playback device taken at a time given by the associated timestamp. Further, in at least one example, the records are configured to store timestamps in association with values indicative of a segment of movement (starting and ending coordinates) of a portable playback device taken at times given by associated timestamps. Other examples of position information and/or movement information, and structures configured to store the same, will be apparent in view of this disclosure.

According to certain embodiments, one or more of the network devices 706 may be designated as a “hub” device that collects the detection information from the network devices and the movement information provided by the portable playback device 704 and records the information to determine patterns of movement and/or behavior for the portable playback device 704 over time. In other examples, the portable playback device 704 may be designated as the hub device. In other examples, at least part of the hub device functionalities can be implemented by a computing system (e.g., a cloud computing system) operating in association with the media playback system. The hub device can be configured to determine a relative location of the portable playback device 704 (i.e., location in the environment 700 relative to one or more of the network devices 706) and a path of movement of the portable playback device 704 based on the collected information and take various actions based on the determined location and path of movement, as discussed in more detail below. In certain examples, one or more of the network devices 706 may have greater processing capabilities than others of the network devices, and one of these higher-capability playback devices may be designated as the hub device. Furthermore, designation as the hub device need not be permanent. Different network devices 704, 706 may be designated as the hub device at different times depending on various factors, including, for example, a state of activity of one or more network devices. For example, at a certain time, if the network device 706b is engaged in playback of audio content whereas network device 706a is not, it may be preferable to designate network device 706a as the hub device. System state information stored by the hub device can be transferred from one network device 706 to another as the hub device designation changes.

To acquire and report the detection information using an appropriate wireless communication and/or sensing capability, the network devices 706 may each host an instance of the positioning system application 600 discussed above. The portable playback device 704 may also host an instance of the positioning system application 600. Through the positioning system application 600, the portable playback device 704 and/or the network devices 706 may communicate localization information (e.g., movement information or presence detection information) to the designated hub device for use in support of one or more application functionalities of the media playback system.

FIG. 8 is a flow diagram of an example of a method of monitoring movement of the portable playback device 704 in the environment 700 and coordinating network handoffs among network devices according to certain aspects.

Referring to FIGS. 7B and 8, as the portable playback device 704 is moved along a path 712 from the Office 702b (FIG. 7A) towards the Patio 702e (FIG. 7C), the portable playback device 704 may report movement information that is acquired by the hub device (step 802). Depending on the relative locations of the portable playback device 704 and the network device 706 that is designated as the hub device, the hub device may detect the movement report directly from the portable playback device 704, or the movement report may be detected by another network device 706 that communicates the movement information to the hub device over the wireless network (e.g., LAN 11; FIG. 1B). In certain examples, the portable playback device 704 may periodically transmit the movement information. In some examples, the portable playback device 704 may transmit the movement information at predetermined time intervals, such as every few seconds, milliseconds, minutes, or other time intervals. The time intervals may be regular or irregular. In some examples, the portable playback device 704 may transmit movement information more frequently when it is moving than when it is not moving. In some instances, movement of the portable playback device 704 may trigger transmission of the movement information. Thus, the portable playback device 704 may not transmit movement information when it is stationary, and when it moves, may transmit the movement information continuously or at time intervals with a certain frequency/periodicity.

According to certain embodiments, the portable playback device may include one or more motion sensors configured to detect movement of the portable playback device 704. In certain examples, the portable playback device 704 may include an inertial measurement unit (IMU) that may detect and report positional information for the portable playback device 704. The IMU may detect linear acceleration of the portable playback device 704 using one or more accelerometers and rotational rate using one or more gyroscopes, for example. The IMU measurements may be used to perform “dead reckoning” position calculations to track movement of the portable playback device 704 as it is moved through the environment 700. In certain examples, the movement information reported to the hub device from the portable playback device 704 may include the IMU measurement data and/or positional information calculated using the IMU measurement data.

In other examples, the portable playback device may include one or more other motion sensors and/or systems in addition to or instead of an IMU. For example, the portable playback device 704 may include one or more discrete accelerometers and/or gyroscopes that are not part of an IMU but may be used to collect movement data. The portable playback device 704 may include a global positioning system (GPS) unit to acquire GPS-based positional data either instead of or in addition to IMU and/or other sensor data. As discussed above, regardless of the underlying technology or sensors used to acquire the position measurements, the positioning system application 600 can provide a common interface to accept incoming data from any of various sources and over any of various communications channels or protocols, and coordinate transmission of the movement information to the hub device.

Referring again to FIG. 8 and to FIG. 7B, as the portable playback device 704 is moved along a path of movement 712, the portable playback device 704 reports its movement information to the hub device, as discussed above. Furthermore, one or more network devices 706 that are in proximity to the portable playback device 704 may detect the presence of the portable playback device and report that presence detection information to the hub device (step 804). As shown in FIG. 7B, the path of movement 712 includes a path that passes through the areas designated as the Living Room 702d, Kitchen 702c, and Dining Room 702f. Accordingly, as the portable playback device 704 is moved along the movement path 712, at various times, the network devices 706b-f may detect the presence of the portable playback device 704. Those network devices 706b-f that are not presently acting as the hub device may report the detection information to the hub device. If the hub device is one of the network devices 706a-f, the hub device may directly detect the presence of the portable playback device 704. Thus, the hub device may acquire the presence detection information directly and/or from other network devices 706.

According to certain embodiments, presence detection can be accomplished via transmission (by the portable playback device 704) and detection (by one or more network devices 706) of communications signals, such as audio signals (e.g., using ultrasound) or radio frequency signals (e.g., via WI-FI, BLUETOOTH, UWB, or another radio frequency communications technique). In certain examples, the portable playback device 704 may be configured to periodically output a presence alert signal that may be detected by one or more of the network devices 706. In some examples, the portable playback device 704 may output the presence alert signal with the same or similar timing as the transmission of the movement information 804. In other instances, the portable playback device 704 may transmit the presence alert signal more frequently or less frequently than the movement information. In other examples, the portable playback device 704 may transmit the presence alert signal according to a predefined schedule or upon instruction/request by the hub device or another network device in the media playback system.

In certain examples, the presence alert signals are audio signals, such as audio chirps, that can be detected by the microphone(s) (e.g., microphone(s) 222) of nearby NMDs or NMD-equipped playback devices. The audio signals may be ultrasonic signals, for example. An audio signal can be represented by a time-frequency representation, having identifiable acoustic characteristics or patterns (such as one or more tones of particular frequencies or symbols) over time. To enable identification of the transmitting playback device, the time-frequency representation of the audio signal can be unique to each playback device transmitting the audio signal. For example, the audio signal may include an identifier or a code for the playback device playing the audio signal. Each encoded identifier may be different and encoded as a set of tones, for example. Each tone or symbol can be in the form of a pulse where the tone has a duration, envelope length, and a guard interval. The duration of a particular tone can be the time between the beginning and end of the pulse (e.g., 5-15 milliseconds), and the envelope length can be the length of time that pulse takes to reach maximum magnitude from zero (e.g., 1-10 milliseconds). The guard interval (i.e. an interval of time) is a period of silence between each tone or before the following tone (e.g., 10-50 milliseconds, such as between about 30-50 milliseconds). Thus, upon detection of an audio signal corresponding to a presence alert signal from the portable playback device 704, the receiving network device 706 can identify the portable playback device 704 as the source of the audio signal. Further examples and details regarding presence detection using audio signals, and in particular, ultrasound signals, are disclosed in U.S. Patent Publication No. 2022/0066008 referenced above.

According to certain examples, presence detection of the portable playback device 704 may be based on line-of-sight signal reception, such as detection of UWB signals emitted by the portable playback device. UWB signals may be used to obtain relatively precise localization information, and therefore may be preferred in some examples. In other examples, the presence alert signals may be radio frequency signals transmitted via WI-FI or BLUETOOTH, for example. According to certain embodiments, it may be preferable to use relatively short-range signals, such as ultrasound, BLUETOOTH, or UWB signals, for presence detection in order to obtain more accurate presence detection and positional information. However, signal strength measurements, such as RSSI measurements, may also be used to increase precision whether short-range or longer-range signal types are used. For example, referring to FIG. 7B, as the portable playback device 704 leaves the Office 702b, it may be close to the network device 706b, which may therefore detect a presence alert signal with higher RSSI than, for example, the network device 706d which may be further away from the portable playback device and may therefore detect the presence alert signal with lower RSSI.

In certain examples, the detection information may include information in addition to an indication that the presence of the portable playback device 704 was detected. For example, in the example shown in FIG. 7B, the portable playback device 704 is at least temporarily closer to the network device 706b than to the network device 706c. This difference in relative position may be determined based on various aspects, such as relative signal strength, for example. In addition, where the presence alert signals emitted by the portable playback device are audio signals, Doppler shift measurements between multiple tones or multiple instances of the presence alert signal may be used to determine whether the portable playback device 704 is moving towards or away from a given network device 706. This information may be particularly useful in estimating the movement path 712 of the portable playback device 704. U.S. Patent Publication No. 2022/0066008 referenced above discloses examples of determining which playback device out of a plurality of playback devices is closest to a portable playback device using techniques applicable to audio signals and as may be applied to the present disclosure, as will be appreciated by those skilled in the art. Further, US Patent Publication Nos. 2021/0099736 and 2021/0297168 referenced above provide examples of using RSSI measurements to obtain positional information, which may also be applied to the presence detection techniques disclosed herein, as will be appreciated by those skilled in the art.

Thus, in steps 802 and 804, as the portable playback device 704 is moved along the movement path 712, the media playback system may collect movement information from the portable playback device 704 and presence detection information from one or more network devices 706. Collecting the presence detection information and movement information over time may allow the system to monitor movement of the portable playback device 704 as it is moved around the environment 700. Furthermore, in certain examples, the media playback system may use the collected movement information and/or presence detection information to estimate the movement path 712 of the portable playback device 704 (step 806). As noted above, doppler measurements or signal strength measurements that indicate whether the portable playback device 704 is moving towards or away from a given network device 706 can be particularly useful in estimating the movement path 712. Estimating the movement path 712 may be useful in assisting the media playback system to appropriately identify and select a network device 706 to become a new source device for the audio content being streamed to the portable playback device 704, as discussed in more detail below.

Referring to FIG. 8, at certain times, various system state information may be communicated between the hub device and the other network devices 706 and/or the portable playback device 704, as indicated at step 808. The hub device may also record and store system state information received from the other network devices 706 and/or the portable playback device 704. System state information may include information that the portable playback device 704 is playing particular audio content and/or that two or more playback devices are playing audio content in synchrony, or that the portable playback device is presently part of a bonded group with one or more network devices 706. In various examples, the system state information may include any information relating to one or more of the network devices 706 and/or the portable playback device 704 that may be useful in localizing the portable playback device and identifying one or more network devices 706 as potential new source devices for the audio content being streamed to the portable playback device 704.

As will be appreciated by those skilled in the art, given the benefit of this disclosure, the steps 802, 804, and 808 may be performed in any order and may be performed simultaneously in certain examples. Further, step 806 may be performed before and/or after step 808, or simultaneously with step 808. Accordingly, the sequence illustrated in FIG. 8 is one example only and not intended to be limiting.

Still referring to FIGS. 7B and 8, as the portable playback device 704 is moved along the movement path 712, at a certain point it may reach an end of the useful wireless range of the source device 708, such that transitioning (handing off) the audio content streaming from the source device to one of the network devices 706 in closer proximity to the portable playback device 704 may be desired. It should be noted that the useful wireless range of the source device 708 includes the range over which the signal strength is sufficient to support streaming of the audio content to the portable playback device 704 such that the portable playback device can playback the audio content without noticeable gaps and/or other degraded quality that would be noticed by the user, as may be caused by very low signal strength in the first wireless communication link 710. In certain aspects, monitoring and recording the system state information (step 808) may include monitoring a signal strength of the first wireless communication link 710 between the source device 708 and the portable playback device 704. This monitoring may be performed in part by the portable playback device 704 and/or the source device 708, which may communicate associated information to the hub device. In certain aspects, the portable playback device 704 and/or the source device 708 may determine when the signal strength of the first wireless communication link 710 falls below a predetermined threshold value, e.g., >=−70 dBm, >=−80 dBm, or >=−90 dBm. The portable playback device 704 and/or the source device 708 may communicate a link status signal to the hub device indicating signal strength of the first wireless communication link 710. In some examples, the portable playback device and/or the source device 708 may only transmit the link status signal based on the signal strength of the first wireless communication link 710 falling below the threshold value. In such cases, detecting the link status signal may indicate to the hub device that the portable playback device 704 is moving away from the source device 708 and that the system should prepare to handoff the audio content streaming to another network device 706.

In other examples, handoff of the audio content streaming may be performed solely based on the movement of the portable playback device (e.g., as determined through steps 802, 804, and optionally 806 discussed above), without monitoring the signal strength of the first wireless communication link 710. Such an approach may result in some handoffs occurring when not strictly necessary (e.g., the portable playback device could still receive the audio content stream from the source device when handoff to another network device 706 occurs), but may use fewer computing resources (particularly those of the portable playback device 704) by eliminating the actions of monitoring the signal strength, comparing it against a threshold value, and transmitting the link status signal. In some instances, handoff from one source device to another network device may be based on a combination of the portable playback device 704 having changed location by a certain predetermined amount and an available network device (i.e., one available to become the new source device) being within a certain proximity to the portable playback device 704. Proximity of a network device 706 to the portable playback device may be determined from the movement information and/or presence detection information acquired in steps 802 and 804 discussed above, and availability to act as a source device may be determined from system state information (e.g., the proximate network device is not presently playing back other audio content that may prevent it from streaming the appropriate audio content to the portable playback device). In some instances, a threshold for a change in location (e.g., displacement) of the portable playback device being sufficient to trigger a handoff procedure may be determined based on the layout of the environment 700 or other factors that may be stored as system state variables (e.g., estimated BLUETOOTH or other wireless signal ranges within the environment, etc.).

As shown in FIG. 7B, as the portable playback device 704 is moved along the movement path 712, at certain times it may be in proximity to various others of the network devices 706, including network devices 706b-e, for example. Accordingly, based on the collected location information (e.g., the movement information acquired from the portable playback device 704 (step 802 in FIG. 8), the presence detection information acquired from the network devices 706 (step 804), and optionally the estimated trajectory of the movement path 712 (step 806)), the media playback system may identify one or more network devices 706 as potential new source devices for the audio content streaming to the portable playback device 704 (step 810). For example, in the scenario illustrated in FIG. 7B, network devices 706b, 706c, and 706e are in relatively close proximity to the portable playback device 704 at certain points along the movement path 712, and at other points, as the portable playback device 704 approaches and reaches the Patio 702e, network devices 706c and 706f may be in closer proximity (FIG. 7C). For the location of the portable playback device 704 shown in FIG. 7B, network devices 706b, 706c, and 706e may be identified as potential new source devices, for example.

According to certain aspects, the media playback system may take certain actions to prepare or “ready” one or more of the network devices 706b, 706c, and/or 706e to become new source devices such that the handoff procedure can be performed more quickly and seamlessly when and if it becomes necessary (step 812). For example, to ready the network device(s) 706b, 706c, and/or 706e, the media playback system may identify the audio content being played back by the portable playback device 704, and cause one or more of the network devices 706b, 706c, and/or 706e to store a buffered portion of the audio content in memory (e.g., memory 213; FIG. 2A). The one or more network devices 706b, 706c, and/or 706e may receive the audio content over the local network, for example, and store the buffered portion of audio content in memory concurrently with the audio content still being streamed from the source device 708 to the portable playback device 704. Thus, readying the one or more network devices 706b, 706c, and/or 706e may be performed without interrupting or affecting playback of the audio content by the portable playback device 704. In further examples, readying the one or more network devices 706b, 706c, and/or 706e may also include making any necessary preparations to establish a wireless communication link with the portable playback device for streaming the audio content. For example, where the wireless communication links are BLUETOOTH links, for example, readying the one or more network devices 706b, 706c, and/or 706e may include activating BLUETOOTH capabilities and/or preparing to connect to the portable playback device. In some instances, readying the one or more network devices 706b, 706c, and/or 706e may also include identifying the audio content currently being played back by the portable playback device, identifying a source for the audio content, and retrieving/buffering the audio content to be streamed. The playback devices being readied can receive (e.g., from the portable device or other devices in the system) data indicating the content currently being played back by the playback device. This data can include a URL to the content in a media content service provider server, and/or metadata such as a name of a song, an album, an artist, a playlist, etc. that the playback devices can use to identify and retrieve the audio content. The audio content can be retrieved from any audio content source that the playback devices have access to. In some instances, the audio content source can be the same audio content source from which the portable playback device is currently playing back audio (e.g., the device 708 itself, or any content source from which the device 708 was originally streaming audio content from, such as media streaming service server). For example, the playback devices being readied can receive information identifying the media content being played back by the portable device and determine a media content service provider from which such content is being streamed. The playback devices can then retrieve the content form the same media content provider and/or an alternative media content provider which may have the same or similar content available.

In certain examples, the network devices may be readied after the media playback system detects that the portable playback device 704 has been in the vicinity of a particular network device for a certain amount of dwell time. For example, the media playback system may enforce a condition in which the portable playback device 104 must be within range of a particular playback device 106 for a period of, e.g., 1, 2, 5, 10 seconds or more before initiating a handoff to that device. Enforcing a certain amount of dwell time may prevent a premature handoff between devices.

In certain examples, based on continued monitoring of the movement of the portable playback device 704 and considerations discussed above, the media playback system may make a determination at step 814 to initiate handoff of the audio content streaming from the source device 708 to one of the readied network devices 706.

In certain examples, selection of the network device 706 to become the new source device may be based on updated location information. For example, as shown in FIG. 7B, as the portable playback device 704 is moved along the movement path 712, the collected location information may indicate that it is moving towards the network device 706c and away from the network device 706b. Accordingly, the network device 706c may be selected to become the new source device. In other examples, system state information about the readied network devices 706 may be used to select a new source device from among two or more identified potential source devices. For example, system state information may indicate that one network device has greater resources available for streaming the audio content to the portable playback device 704 than does another. In another example, system state information may be used to exclude one or more network devices that were identified as potential source devices based on location information in step 810. For example, system state information may indicate that the network device 706e is unavailable to stream the audio content because it is currently playing back different audio content, or is part of an active bonded group, or lacks appropriate wireless communications capability to establish a wireless communication link with the portable playback device 704 for streaming the audio content. Thus, in various examples, system state information may be used in the selection of a new source device prior to readying one or more network devices for handoff in step 812 and/or after two or more network devices have been readied for potential handoff.

In certain examples, the media playback system may be configured to implement one or more processes for prioritizing between the audio data stream intended for the portable playback device 704 and one or more audio streams that may be being played back in areas within the environment 700 that the user (and therefore the portable playback device) may enter and/or move through along the movement path 712. For example, as discussed above, a system state variable that may be considered in identifying and/or selecting a network device 706 as a potential source device may be information about whether or not that network device is already streaming and/or playing back other audio content. In certain examples, if multiple network devices 706 are available, based on the location information, as potential new source devices, a network device that is already playing back other audio content may be eliminated from the list of potential new source devices. In other examples, if based on the location information, the only potential new source devices are network devices 706 that are already playing back other audio content, the system may implement prioritization rules to determine which audio stream may be temporarily interrupted or downgraded in quality to accommodate the other. Program instructions defining such prioritization rules may be encoded in the software code 214 stored in the memory 213 of the hub device and/or other network devices 706, for example. In some instances, the network devices 706 can be capable of handling coexistence of various simultaneous streams, so that the network devices 706 can play back a first stream of media content while streaming a second stream of media content to be played back by the portable playback device. In this way, playback of audio content by the network devices 706 does not need to be interrupted when streaming content to the portable playback device.

Once a network device has been identified and selected as a new source device for the portable playback device, the handoff procedure can be initiated in step 814. According to certain examples, performing the handoff procedure may include establishing a second wireless communication link between the portable playback device 704 and the new source device (step 816). In the example shown in FIG. 7B, the selected new source device is the network device 704c, and thus a second wireless communication link 714 is established between the portable playback device 704 and the network device 706c. The second wireless communication link 714 may be a BLUETOOTH link, for example. In certain examples, the second wireless communication link 714 can be established concurrently with the first wireless communication link 710. Thus, the portable playback device 704 may continue to receive a first audio data stream comprising the audio content over the first wireless communication link 710 while the network device 706c prepares to begin streaming the audio content (via a second audio data stream) over the second wireless communication link 714.

The handoff procedure may also include various synchronization or other transition actions (optional step 818) to transition the portable playback device 704 from playing back the audio content based on the first audio data stream to playing back the audio content based on the second audio data stream. For example, the network device 706c and the portable playback device 704 may exchange timing information to synchronize the first and second audio data streams and identify times at which the network device 706c begin streaming the audio content to the portable playback device and the portable playback device begins playback of the audio content based on the second audio stream so as to minimize any “gaps” in the playback resulting from the transition from one audio stream to the other. In some examples, during the handoff procedure, the new source device (e.g., network device 706c) may form a temporary synchrony group with the portable playback device 704 to synchronize the audio data streams and coordinate streaming and playback of the audio content. In certain examples, the portable playback device 704 may implement a technique such as “earcon masking” to address the loss of any audio content samples during the handoff procedure. Earcon masking refers to the playing of a brief tone or chime that alerts the user to network handoff and masks some or all lost audio content samples, thus making an audible transition less jarring to the user.

In further examples, one or both audio streams may be downsampled for a limited time period during the handoff to address bandwidth constraints in the wireless communication link(s) 710, 714 that may be present during the handoff procedure (e.g., due to the need to support audio streaming, least briefly, over both links). Thus, in certain examples, during the handoff procedure, the first audio data stream can be transmitted to the portable playback device via the first wireless communication link 710 at a first sample rate, and the second audio data stream can be transmitted to the portable playback via the second wireless communication link 714 at a second sample rate that is less than the first sample rate. After the handoff has been successfully established, the sample rate of the second audio data stream may be increased, optionally to the same as the first sample rate. Other examples of seamless transition od source of media content are disclosed in U.S. Pat. No. 11,418,556, filed Mar. 22, 2021, which is incorporated herein by reference in its entirety.

At step 820, the handoff procedure is completed, and the new source device (e.g., network device 706c in the example of FIG. 7B) streams the audio content seamlessly to the portable playback device 704.

Referring again to FIG. 7B and to FIG. 7C, as discussed above, in one example, as the portable playback device 704 moves along the movement path 712, a handoff occurs from the source device to the network device 706c, for example. As the portable playback device continues along the movement path 712 towards the Patio 702e, the network device 706c may remain as the source device, or another handoff may occur to transition the audio content from the network device 706c to another network device, such as network device 706f, for example. Alternatively, for example, in the first handoff from the source device 708, the network device 706b may be selected as the new source device, rather than the network device 706c. In such an example, the network device 706b may establish a wireless link 716 with the portable playback device, as shown in FIG. 7B and perform the handoff procedures as discussed above. Accordingly, as the portable playback device 704 continues along the movement path 712, moving away from the network device 706b and towards the network device 706c, a second handoff may occur to transition the audio content streaming from the network device 706b as the source device to the network device 706c as a new source device. Thus, the network device 706c may establish a wireless communication link 718 with the portable playback device 704, as shown in FIG. 7C, and perform the handoff procedures as discussed above. Numerous other examples and scenarios may be implemented, as will be appreciated by those skilled in the art, given the benefit of this disclosure.

Thus, as illustrated in FIG. 8, the media playback system may continue to monitor the movement of the portable playback device 704 through the environment 700, and based on the collected location information and optionally also on updated system state information, coordinate and perform network handoffs among any of the network devices 706 that are or become available as source devices for the portable playback device 704.

Aspects and embodiments therefore provide network devices, systems, and methods that allow for monitoring the movement of portable playback devices through an environment and performing automatic network handoffs to maintain consistent streaming of audio data to the portable playback device(s) using one or more other network devices as relays. As discussed above, the techniques disclosed herein may allow for an improved user experience as the user may move freely about the environment 700 without having to remain close to an original source device 708 of audio content being streamed to their portable playback device.

### V. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain aspects of the present disclosure can be practiced without certain, specific details. In other instances, well known methods, procedures, components, and circuitry have not been described in detail to avoid unnecessarily obscuring aspects of the examples and aspects of the present technology. Accordingly, the scope of the present disclosure is defined by the appended claims rather than the forgoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. Examples

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

(Example 1) A system comprising: at least one processor; and at least one non-transitory computer-readable memory storing program instructions that are executable by the at least one processor such that the system is configured to perform a method, wherein the method comprises: streaming audio content over a first wireless communication link between a portable playback device and a first playback device; playing back, via the portable playback device, the audio content streamed over the first wireless communication link; detecting a change in location of the portable playback device; after detecting the change in location, readying a second playback device for audio-content streaming, wherein readying the second playback device comprises storing a buffered portion of the audio content in memory of the second playback device; detecting a further change in location of the portable playback device; and after detecting the further change in location of the portable playback device: streaming the buffered portion of the audio content over a second wireless communication link between the second playback device and the portable playback device; and continuing playback of the audio content via the portable playback device, wherein continuing playback of the audio content comprises playing back the buffered portion of the audio content streamed over the second wireless communication link.

(Example 2) The system of Example 1, wherein the buffered portion of the audio content is streamed over the second wireless communication link concurrently with the streaming of the audio content over the first wireless communication link.

(Example 3) The system of Example 1, wherein the method further comprises storing the buffered portion of the audio content in memory of the second playback device while concurrently streaming the audio content over the first wireless communication link.

(Example 4) The system of Example 1, wherein the method further comprises playing back the audio content via the first playback device in synchrony with the playback of the audio content via the portable playback device.

(Example 5) The system of Example 4, wherein the method further comprises ceasing playback of the audio content via the first playback device after detecting the further change in location of the portable playback device.

(Example 6) The system of Example 4, wherein the method further comprises playing back the audio content via the second playback device in synchrony with the playback of the audio content via the portable playback device after detecting the further change in location of the portable playback device.

(Example 7) The system of Example 1, wherein detecting the change in location of the portable playback device and the further change in location of the portable playback device comprises comparing each detected change in location to a threshold value, and wherein the method further comprises determining to ready the second playback device based on each comparison to the threshold value.

(Example 8) The system of Example 7, wherein determining to ready the second playback device is further based on a type of communication protocol of at least one of the first wireless communication link and the second wireless communication link.

(Example 9) The system of Example 1, wherein the audio content comprises first audio content, and wherein the method further comprises: playing back the second audio content via the second playback device; and ceasing playback of the second audio content after detecting the further change in location of the portable playback device.

(Example 10) The system of Example 1, wherein: streaming the first audio content via the first communication link comprises transmitting to the portable playback device first audio data corresponding to the audio content, wherein the first audio data has a first sample rate; and streaming the buffered portion of the audio content via the second communication link comprises transmitting to the portable playback device second audio data corresponding to the audio content, wherein the second audio data has a second sample rate that is less than the first sample rate.

(Example 11) The system of Example 10 wherein the method further comprises after streaming the buffered portion of the audio content via the second communication link, transmitting to the portable playback device third audio data corresponding to the audio content, wherein the third audio data has a third sample rate that is different than the second sample rate.

(Example 12) The system of Example 10, wherein the third sample rate is equal to the first sample rate.

(Example 13) The system of Example 1, wherein the first communication link corresponds to a first communication protocol, and the second communication link corresponds to a second communication protocol different than the first protocol.

(Example 14) The system of Example 1, wherein the audio content comprises first audio content, and wherein the method further comprises: streaming second audio content to another playback device over a third communication link between the other playback device and the second playback device; comparing a priority of the second communication link to a priority of the third communication link; and determining to ready the second playback device for playback of the first audio content based on the comparison of the priority of the corresponding first and second communication links.

(Example 15) The system of Example 1, wherein the method further comprises playing back an earcon via the portable playback device after detecting the further change in location of the portable playback device.

(Example 16) A method of audio playback, the method comprising: streaming audio content over a first wireless communication link between a portable playback device and a first playback device; playing back, via the portable playback device, the audio content streamed over the first wireless communication link; detecting a change in location of the portable playback device; after detecting the change in location, readying a second playback device for audio-content streaming, wherein readying the second playback device comprises storing a buffered portion of the audio content in memory of the second playback device; detecting a further change in location of the portable playback device; and after detecting the further change in location of the portable playback device: streaming the buffered portion of the audio content over a second wireless communication link between the second playback device and the portable playback device; and continuing playback of the audio content via the portable playback device, wherein continuing playback of the audio content comprises playing back the buffered portion of the audio content streamed over the second wireless communication link.

(Example 17) The method of Example 16, wherein the buffered portion of the audio content comprises streaming the buffered portion of the audio content over the second wireless communication link concurrently with the streaming of the audio content over the first wireless communication link.

(Example 18) The method of Example 16, further comprising storing the buffered portion of the audio content in memory of the second playback device while concurrently streaming the audio content over the first wireless communication link.

(Example 19) The method of Example 16, further comprising playing back the audio content via the first playback device in synchrony with the playback of the audio content via the portable playback device.

(Example 20) The method of Example 19, further comprising ceasing playback of the audio content via the first playback device after detecting the further change in location of the portable playback device.

(Example 21) The method of Example 19, further comprising playing back the audio content via the second playback device in synchrony with the playback of the audio content via the portable playback device after detecting the further change in location of the portable playback device.

(Example 22) The method of Example 16, wherein detecting the change in location of the portable playback device and the further change in location of the portable playback device comprises comparing each detected change in location to a threshold value, and wherein the method further comprises determining to ready the second playback device based on each comparison to the threshold value.

(Example 23) The method of Example 22, wherein determining to ready the second playback device is further based on a type of communication protocol of at least one of the first wireless communication link and the second wireless communication link.

(Example 24) The method of Example 16, wherein the audio content comprises first audio content, and further comprising: playing back the second audio content via the second playback device; and ceasing playback of the second audio content after detecting the further change in location of the portable playback device.

(Example 25) The method of Example 16, wherein: streaming the first audio content via the first communication link comprises transmitting to the portable playback device first audio data corresponding to the audio content, wherein the first audio data has a first sample rate; and streaming the buffered portion of the audio content via the second communication link comprises transmitting to the portable playback device second audio data corresponding to the audio content, wherein the second audio data has a second sample rate that is less than the first sample rate.

(Example 26) The method of Example 25, further comprising after streaming the buffered portion of the audio content via the second communication link, transmitting to the portable playback device third audio data corresponding to the audio content, wherein the third audio data has a third sample rate that is different than the second sample rate.

(Example 27) The method of Example 26, wherein the third sample rate is equal to the first sample rate.

(Example 28) The method of Example 16, wherein streaming the audio content over the first wireless communication link comprises streaming the audio content using a first communication protocol, and wherein streaming the audio content over the second wireless communication link comprises streaming the audio content using second communication protocol different than the first protocol.

(Example 29) The method of claim 16, wherein the audio content comprises first audio content, and further comprising: streaming second audio content to another playback device over a third communication link between the other playback device and the second playback device; comparing a priority of the second communication link to a priority of the third communication link; and determining to ready the second playback device for playback of the first audio content based on the comparison of the priority of the corresponding first and second communication links.

(Example 30) The method of Example 16, further comprising playing back an earcon via the portable playback device after detecting the further change in location of the portable playback device.

(Example 31) A portable playback device configured to implement the method of any one of Examples 16-30.

(Example 32) The portable playback device of Example 31, wherein the network device is a playback device.

(Example 33) The portable playback device of Example 32, wherein the at least one non-transitory computer-readable medium further comprises program instructions that are executable by the at least one processor such that the portable playback device is configured to buffer at least a portion of the first stream of audio data, and wherein the program instructions that are executable by the at least one processor such that the portable playback device is configured to determine the future time at which to transition from playing back the audio content using the first stream of audio data to playing back the audio content using the second stream of audio data comprise program instructions that are executable by the at least one processor such that the portable playback device is configured to determine the future time at which to transition from playing back the audio content using the first stream of audio data to playing back the audio content using the second stream of audio data based on an amount of data remaining in the buffered portion of the first stream of audio data.

(Example 34) The portable playback device of Example 33, wherein the at least one non-transitory computer-readable medium further comprises program instructions that are executable by the at least one processor such that the portable playback device is configured to buffer at least a portion of the second stream of audio data, and wherein the program instructions that are executable by the at least one processor such that the portable playback device is configured to identify the point in the second stream of audio data from which to begin to play back of the audio content using the second stream of audio data comprise program instructions that are executable by the at least one processor such that the portable playback device is configured to (i) determine a point in the buffered portion of the first stream of audio data that corresponds to the future time and (ii) identify a point in the buffered portion of the second stream of audio data that aligns with the determined point in the buffered portion of the first stream of audio data.

(Example 35) The portable playback device of any of Examples 31-34, wherein to detect the indication that a source of the audio content is to transition from a source of the first stream of audio data to a first playback device, the portable playback device is configured to: determine that a first distance between the portable playback device and a source of the first stream of audio data is increasing; and determine that a second distance between the portable playback device and the first playback device is decreasing.

(Example 36) The portable playback device of any one of Examples 31-35, wherein the portable playback device comprises headphones.

(Example 37) A method for controlling audio playback by a portable device, the method comprising: while playing back, via the portable playback device, audio content streamed over a first wireless communication link between the portable playback device and a first playback device, detecting a change in location of the portable playback device; after detecting the change in location, streaming the audio content over a second wireless communication link between the portable playback device and a second playback device; and continuing playback of the audio content via the portable playback device by playing back the audio content streamed over the second wireless communication link.

(Example 38) The method of Example 37, further comprising, while the portable playback device is playing back the audio content streamed over the first wireless communication link, receiving audio content streamed over the first wireless communication link from the first playback device.

(Example 39) The method of Example 37 or 38, further comprising playing back the audio content via the first playback device in synchrony with the playback of the audio content via the portable playback device.

(Example 40) The method of Example 39, further comprising, after detecting the change in location of the portable playback device, at least one of ceasing playback of the audio content via the first playback device, or playing back, by the second playback device, the audio content in synchrony with the playback of the audio content via the portable playback device.

(Example 41) The method of any one of Examples 37-40, wherein the audio content comprises first audio content, and the method further comprises playing back a second audio content via the second playback device, and ceasing playback of the second audio content after detecting the further change in location of the portable playback device.

(Example 42) The method of any one of Examples 37-41, wherein streaming the audio content over the first wireless communication link comprises streaming the audio content using a first communication protocol, and wherein streaming the audio content over the second wireless communication link comprises streaming the audio content using second communication protocol different than the first protocol.

(Example 43) The method of any one of Examples 37-42, wherein the audio content comprises first audio content, and further comprising: streaming second audio content to another playback device over a third communication link between the other playback device and the second playback device; comparing a priority of the second communication link to a priority of the third communication link; and determining to cause the second playback device to stream the audio content via the second wireless communication link based on the comparison of the priority of the corresponding first and second communication links.

(Example 44) The method of any one of Examples 37-43, further comprising playing back an earcon via the portable playback device after detecting the further change in location of the portable playback device.

(Example 45) The method of any one of Examples 37-44, further comprising determining to stream the audio content via the second playback device based on a type of communication protocol of at least one of the first wireless communication link and the second wireless communication link.

(Example 46) The method of any one of Examples 37-45, wherein the change in location is a first change in location, the method further comprising, before detecting the first change in location, detecting a second location, and, in response to detecting the second change in location, causing the second playback to store a buffered portion of the audio content in memory of the second playback device; and wherein streaming the audio content via the second communication link comprises streaming the buffered audio content to the portable playback device.

(Example 47) The method of any one of Examples 37-46, wherein streaming the buffered portion of the audio content comprises streaming the buffered portion of the audio content over the second wireless communication link concurrently with the streaming of the audio content over the first wireless communication link.

(Example 48) The method of any one of Examples 37-47, further comprising storing the buffered portion of the audio content in memory of the second playback device while concurrently streaming the audio content over the first wireless communication link.

(Example 49) The method of any one of Examples 37-48, wherein streaming the first audio content via the first communication link comprises transmitting to the portable playback device first audio data corresponding to the audio content, wherein the first audio data has a first sample rate, and wherein streaming the buffered portion of the audio content via the second communication link comprises transmitting to the portable playback device second audio data corresponding to the audio content, wherein the second audio data has a second sample rate that is less than the first sample rate.

(Example 50) The method of Example 49, further comprising after streaming the buffered portion of the audio content via the second communication link, transmitting to the portable playback device third audio data corresponding to the audio content, wherein the third audio data has a third sample rate that is different than the second sample rate.

(Example 51) The method of Example 50, wherein the third sample rate is equal to the first sample rate.

(Example 52) The method of any one of Examples 37-51, wherein detecting the change of location is based on location information comprising at least one of detecting, by one or more network devices of the media playback system, a presence of the portable playback device when the portable playback device is in proximity to the respective one or more network devices, or detecting, via one or more sensors of the portable playback device, movement of the playback device.

(Example 53) The method of Example 52, further comprising, determining, by one or more network devices of the media playback system, a relative location of the portable playback device relative to one or more network devices of the media playback system based on the location information.

(Example 54) The method of one of Examples 52 or 53, wherein determining the relative location of the portable playback device comprise determining a path of movement of the portable playback device based on the location information.

(Example 55) The method of Example 54, further comprising determining one or more network devices in proximity to the path of movement of the portable playback device, and selecting the second playback device from the one or more network devices in proximity to the path of movement of the portable playback device.

(Example 56) The method of any one of Examples 52-55, wherein the portable playback device provides movement information to at least one network device.

(Example 57) The method of any one of Examples 37-56, further comprising determining to steam the audio content via the second playback device based at least in part on system state information corresponding to the second playback device.

(Example 58) The method of any one of Examples 37-57, further comprising determining to steam the audio content via the second playback device based on a signal strength of the first wireless communication link falling below a threshold value.

(Example 59) The method of any one of Examples 37-58, further comprising determining to steam the audio content via the second playback device when the portable playback device has moved more than a threshold amount, and the second playback device is within a threshold proximity to the portable playback device.

(Example 60) The method of any one of Examples 37-59, wherein, while a third playback device is within a threshold proximity to the portable playback device, forgoing selecting the third playback device to stream the audio content to the portable playback device based on state information associated with the third device indicating that the third device is currently playing back second audio content.

(Example 61) The method of any one of Examples 37-60, wherein detecting the change in location comprises detecting one or more playback devices positioned proximate to a path of movement of the portable playback device, wherein the second playback device is one of the one or more playback devices positioned proximate to the path of movement of the portable playback device.

(Example 62) The method of any one of Examples 37-61, further comprising receiving an indication to transition from receiving the audio content from the first playback device to receiving the audio content from the second playback device, and in response to the received indication: establishing the second wireless communication link between the portable playback device and the second playback device, receiving the audio content via the second wireless communication link, and transitioning from playing back the audio content received via the first wireless communication link to playing back the audio content received via the second communication link.

(Example 63) The method of Example 62, wherein transitioning from playing back the audio content received via the first wireless communication link to playing back the audio content received via the second communication link comprises determining a future time at which to transition from playing back the audio content using the first stream of audio data to playing back the audio content using the second stream of audio data, identifying a point in the second stream of audio data from which to begin playback of the audio content using the second stream of audio data, and at the future time, transitioning from playing back the audio content using the first stream of audio data to playing back the audio content using the second stream of audio data beginning from the identified point in the second stream of audio data.

(Example 64) The method of Example 63, further comprising buffering at least a portion of the first stream of audio data, and wherein determining the future time at which to transition from playing back the audio content using the first stream of audio data to playing back the audio content using the second stream of audio data is based on an amount of data remaining in the buffered portion of the first stream of audio data.

(Example 65) The method of Example 64, further comprising buffering at least a portion of the second stream of audio data, wherein identifying a point in the second stream of audio data from which to begin to playback of the audio content using the second stream of audio data comprises: determining a point in the buffered portion of the first stream of audio data that corresponds to the future time, and identifying a point in the buffered portion of the second stream of audio data that aligns with the determined point in the buffered portion of the first stream of audio data.

(Example 66) The method of any one of Examples 62-65, wherein detecting the indication that a source of the audio content is to transition from a source of the first stream of audio data to a first playback device comprises: determining that a first distance between the portable playback device and a source of the first stream of audio data is increasing, and determining that a second distance between the portable playback device and the first playback device is decreasing.

(Example 67) The method of any one of Examples 37-66, wherein the portable playback device comprises headphones.

(Example 68) A system comprising at least one processor, and at least one non-transitory computer-readable memory storing program instructions that are executable by the at least one processor such that the system is configured to perform a method according to any one of Examples 37-67.

1. A method for controlling audio playback by a portable device, the method comprising:
playing back audio content via a first playback device;
while playing back, via the portable playback device and in synchrony with playback of the audio content via the first playback device, the audio content streamed over a first wireless communication link from the first playback device to the portable playback device, detecting a change in location of the portable playback device;
after detecting the change in location, streaming the audio content over a second wireless communication link to the portable playback device from a second playback device;
ceasing, responsive to detecting the change in location of the portable playback device, playback of the audio content via the first playback device; and
continuing playback of the audio content via the portable playback device by playing back, via the portable playback device, the audio content streamed to the portable playback device over the second wireless communication link.

2. (canceled)

3. (canceled)

4. The method of claim 1, further comprising, after detecting the change in location of the portable playback device,
playing back, by the second playback device, the audio content in synchrony with the playback of the audio content via the portable playback device.

5. The method of claim 1, wherein the audio content comprises first audio content, and the method further comprises:
playing back second audio content via the second playback device; and
ceasing playback of the second audio content after detecting the change in location of the portable playback device.

6. The method of claim 1, wherein streaming the audio content over the first wireless communication link comprises streaming the audio content using a first communication protocol, and wherein streaming the audio content over the second wireless communication link comprises streaming the audio content using second communication protocol different than the first protocol.

7. The method of claim 1, wherein the audio content comprises first audio content, and further comprising:
streaming second audio content to another playback device over a third communication link between the other playback device and the second playback device;
comparing a priority of the second communication link to a priority of the third communication link; and
determining to cause the second playback device to stream the first audio content to the portable playback device via the second wireless communication link based on the comparison of the priority of the respective second and third communication links indicating that the priority of the second communication link is higher than the priority of the third communication link.

8. The method of claim 1, further comprising playing back an earcon via the portable playback device after detecting the change in location of the portable playback device.

9. The method of claim 1, further comprising determining to stream the audio content via the second playback device based on a type of communication protocol of at least one of the first wireless communication link and the second wireless communication link.

10. (canceled)

11. (canceled)

12. (canceled)

13. (canceled)

14. (canceled)

15. (canceled)

16. The method of claim 1, wherein detecting the change of location is based on location information comprising at least one of:
detecting, by one or more network devices of the media playback system, a presence of the portable playback device when the portable playback device is in proximity to the respective one or more network devices; and
detecting, via one or more sensors of the portable playback device, movement of the playback device.

17. (canceled)

18. The method of claim 16, wherein determining the relative location of the portable playback device comprise determining a path of movement of the portable playback device based on the location information.

19. The method of claim 18, further comprising determining one or more network devices in proximity to the path of movement of the portable playback device, and selecting the second playback device from the one or more network devices in proximity to the path of movement of the portable playback device.

20. (canceled)

21. The method of claim 1, further comprising determining to steam the audio content via the second playback device based at least in part on system state information corresponding to the second playback device.

22. The method of claim 1, further comprising determining to steam the audio content via the second playback device based on a signal strength of the first wireless communication link falling below a threshold value.

23. The method of claim 1, further comprising determining to steam the audio content via the second playback device when:
the portable playback device has moved more than a threshold amount; and
the second playback device is within a threshold proximity to the portable playback device.

24. The method of claim 1, wherein, while a third playback device is within a threshold proximity to the portable playback device, forgoing selecting the third playback device to stream the audio content to the portable playback device based on state information associated with the third device indicating that the third device is currently playing back other audio content.

25. The method of claim 1, wherein detecting the change in location comprises detecting one or more playback devices positioned proximate to a path of movement of the portable playback device, wherein the second playback device is one of the one or more playback devices positioned proximate to the path of movement of the portable playback device.

26. (canceled)

27. (canceled)

28. (canceled)

29. (canceled)

30. (canceled)

31. (canceled)

32. A system comprising:
a portable playback device;
a plurality of other playback devices;
at least one processor; and
at least one non-transitory computer-readable memory storing program instructions that are executable by the at least one processor such that the system is configured to:
instruct a first playback device of the plurality of other playback devices to play back audio content,
instruct the first playback device to stream the audio content to the portable playback device over a first wireless communication link between the first playback device and the portable playback device,
while the portable playback device is playing back the audio content in synchrony with playback of the audio content via the first playback device, detect a change in location of the portable playback device,
after detecting the change in location, instruct a second playback device of the plurality of other playback devices to stream the audio content to the portable playback device over a second wireless communication link between the portable playback device and the second playback device,
instruct, responsive to detecting the change in location of the portable playback device, the first playback device to cease playback of the audio content, and
instruct the portable playback device to continue playback of the audio content by playing back, via the portable playback device, the audio content streamed to the portable playback device over the second wireless communication link.

33. A portable playback device comprising:
a wireless communications interface;
at least one acoustic transducer;
at least one processor; and
at least one non-transitory computer-readable medium storing program instructions that are executable by the at least one processor such that the portable playback device is configured to:
detect, over a first wireless link established via the wireless communications interface, a first stream of audio data representing audio content;
play back the audio content via the at least one acoustic transducer;
identify one or more playback devices positioned proximate a path of movement of the portable playback device;
detect an indication that a source of the audio content is to transition from a source of the first stream of audio data to a first playback device of the one or more playback devices;
after detecting the indication, establish, via the wireless communications interface, a second wireless link with the first playback device over which to receive a second stream of audio data representing the audio content;
detect, via the wireless communications interface, the second stream of audio data representing the audio content; and
transition from playing back the audio content based on the first stream of audio data to playing back the audio content based on the second stream of audio data.

34. The portable playback device of claim 33, wherein the portable playback device comprises headphones.

35. The portable playback device of claim 33, wherein to detect the indication that the source of the audio content is to transition comprises to:
detect that the portable playback device has moved more than a threshold amount; and
detect that the first playback device is within a threshold proximity to the portable playback device.

36. The portable playback device of claim 33, wherein the first wireless link comprises one of a WIFI link or a BLUETOOTH link; and
wherein the second wireless link comprises the other of the WIFI link or the BLUETOOTH link.
